(19) United States
(12) Patent Application Publication
(10) Pub. No.: US 2021/0009157 A1
(43) Pub. Date: Jan. 14, 2021

(54) DRIVING ASSISTANCE APPARATUS, VEHICLE, DELINQUENT DRIVING DETECTION SYSTEM, AND SERVER DEVICE

(71) Applicant: PANASONIC INTELLECTUAL PROPERTY MANAGEMENT CO., LTD., Osaka (JP)

(72) Inventors: Nobuhiro FUKUDA, Kanagawa (JP); Norihiko KOBAYASHI, Tokyo (JP); Keiji NISHIHARA, Kanagawa (JP); Matthew John LAWRENSON, Lausanne (CH); Julian Charles NOLAN, Lausanne (CH)

(73) Assignee: PANASONIC INTELLECTUAL PROPERTY MANAGEMENT CO., LTD., Osaka (JP)

(21) Appl. No.: 17/033,309

(22) Filed: Sep. 25, 2020

Related U.S. Application Data
(63) Continuation of application No. PCT/JP2019/014373, filed on Mar. 29, 2019.

(30) Foreign Application Priority Data
Mar. 30, 2018 (JP) 2018-070018

(51) Int. Cl. B60W 60/00; G08G 1/00; G01C 21/34; B60W 30/095; G01C 21/36; G06Q 30/00; G06Q 50/26; G06Q 50/30; G06F 16/9537; G06F 16/23; G06F 16/29; H04L 29/08

(52) U.S. Cl. CPC B60W 60/001; B60W 2552/00; G08G 1/20; G01C 21/3461; B60W 30/0956; G01C 21/3691; G06Q 30/0185; G06Q 50/265; G06Q 50/30; G06F 16/9537; G06F 16/2379; G06F 16/29; H04L 67/12; B60W 2556/45; G08G 1/22

(57) ABSTRACT

A driving assistance apparatus performs a delinquent driving detection process. The delinquent driving detection process includes: inquiring of an external database, using information on one or more other vehicles in a vicinity of the vehicle and/or area information including a point where the vehicle is positioned, about whether there is a delinquent driving vehicle that has performed delinquent driving among the one or more other vehicles; detecting presence or absence of delinquent driving by the one or more other vehicles based on an inquiry result from the database; generating, in response to detection of the presence of the delinquent driving, delinquent driving vehicle information including ID information of a delinquent driving vehicle that performs the delinquent driving and traveling trajectory information of the delinquent driving vehicle and the vehicle; and requesting the database that the delinquent driving vehicle information be registered or updated.

### CROSS-REFERENCE TO RELATED APPLICATIONS

This application is a continuation of PCT International Patent Application No. PCT/JP2019/014373 filed on Mar. 29, 2019, which claims the benefit of priority of Japanese Patent Application No. 2018-070018 filed on Mar. 30, 2018, the enter contents of which are incorporated herein by reference.

### FIELD

The present disclosure relates to a driving assistance apparatus, a vehicle, a delinquent driving detection system, and a server device.

### BACKGROUND

US-A1-2014/0236414 discloses a technology for receiving one or more pieces of sensor information indicating respective driving characteristics of a plurality of other vehicles that travel near a first vehicle while the first vehicle that is an autonomous vehicle is traveling on a road, and specifying a second vehicle that performs an aggressive driving action to the first vehicle based on those pieces of sensor information.

### SUMMARY

In order to specifically promote application of an autonomous vehicle (AV), it is considered that the autonomous vehicle will encounter delinquent driving (for example, pulling over due to harassment of another vehicle, and a lane change such as intentionally jumping forward by another vehicle). As a related-art countermeasure against the delinquent driving, for example, a measure such as recording an image during traveling as evidence by a drive recorder mounted on a vehicle has been considered.

However, in consideration of a possibility of occurrence of the delinquent driving to the autonomous vehicle, it is assumed that there will be a major obstacle to application and popularization of the autonomous vehicle if the related-art countermeasure does not function effectively and the related-art countermeasure alone is not sufficient. Patent Literature 1 discloses that the first vehicle controls driving so as to avoid the second vehicle after specifying the aggressive driving action of the second vehicle. However, even when the technology of Patent Literature 1 is used, although it is possible to temporarily escape from the delinquent driving, it is considered difficult to effectively prevent the aggressive driving action itself of the second vehicle.

Since a reduction in a probability of encountering an accident of an autonomous vehicle is expected by specifically providing the autonomous vehicle with an effective means for countering the delinquent driving, business development such as a reduction in automobile insurance premium is also expected. In addition, a possibility that a taxi of a competitor may, for example, interfere with vehicle riding by the delinquent driving cannot be denied in a vehicle-dispatching business (for example, vehicle dispatching of a taxi) or the like where it is assumed that an autonomous vehicle is often used, and it is assumed that crackdown on the delinquent driving is not limited to crackdown on just a crime committed for fun, but is also an important issue when considering profitability of attracting customers and business feasibility.

The present disclosure has been made in view of the above-described circumstances, and an object thereof is to provide a driving assistance apparatus, a vehicle, a delinquent driving detection system, and a server device that efficiently determine whether delinquent driving such as pulling over is performed to an own vehicle during autonomous driving, generate information on another vehicle that performs the delinquent driving as evidence, register or update the generated information in a predetermined database, and effectively promote prevention of the delinquent driving.

The present disclosure provides a driving assistance apparatus including: a processor; and a memory including instructions that, when executed by the processor, cause the processor to perform operations including: a detection process including: determining whether there is a change in a route during autonomous driving based on sensor information obtained from a sensor provided in a vehicle; and outputting an instruction to execute autonomous driving in accordance with a determination result to a vehicle controller; and a delinquent driving detection process including: inquiring of an external database, using at least one of information on one or more other vehicles in a vicinity of the vehicle in autonomous driving and area information including a point where the vehicle is positioned, about whether there is a delinquent driving vehicle that has performed delinquent driving among the one or more other vehicles; detecting presence or absence of delinquent driving by the one or more other vehicles based on an inquiry result from the database; generating, in response to detection of the presence of the delinquent driving, delinquent driving vehicle information including ID information of a delinquent driving vehicle that performs the delinquent driving and traveling trajectory information of the delinquent driving vehicle and the vehicle; and requesting the database that the delinquent driving vehicle information be registered or updated.

The present disclosure provides a vehicle including: the driving assistance apparatus; the sensor; and the vehicle controller.

The present disclosure provides a delinquent driving detection system including: a server device configured to access a database that holds information on a delinquent driving vehicle that has performed delinquent driving; and a vehicle including a sensor and a vehicle controller, wherein the server device and the vehicle are connected to communicate with each other, wherein the vehicle includes: a first processor; and a first memory including first instructions that, when executed by the first processor, cause the first processor to perform first operations including: determining whether there is a change in a route during autonomous driving based on sensor information obtained from the sensor; outputting an instruction to execute autonomous driving in accordance with a determination result to the vehicle controller; and inquiring of the server device, using at least one of information on one or more other vehicles in a vicinity of the vehicle in autonomous driving and area information including a point where the vehicle is positioned, about whether there is a delinquent driving vehicle that has performed delinquent driving among the one or more other vehicles, wherein the server device includes: a second processor; and a second memory including second instructions that, when executed by the second processor, cause the second processor to perform second operations including: in response to an inquiry from the vehicle, accessing the database and receiving an inquiry result in accordance with the inquiry from the vehicle; and transmitting the inquiry result to the vehicle, and wherein the first operations further include: detecting presence or absence of delinquent driving by the one or more other vehicles based on the inquiry result transmitted from the server device and the sensor information obtained from the sensor; generating, in response to detection of the presence of the delinquent driving, delinquent driving vehicle information including ID information of a delinquent driving vehicle that performs the delinquent driving and traveling trajectory information of the delinquent driving vehicle and the vehicle; and requesting the server device that the delinquent driving vehicle information be registered or updated.

The present disclosure provides a server device including: a communication device configured to communicate with a vehicle and a database that holds information on a delinquent driving vehicle that has performed delinquent driving; a processor; and a memory including instructions that, when executed by the processor, cause the processor to perform operations including: receiving, from the vehicle in autonomous driving via the communication device, an inquiry request for inquiring about whether there is a delinquent driving vehicle that has performed delinquent driving among one or more other vehicles in a vicinity of the vehicle in autonomous driving, the inquiry request including at least one of information on the one or more other vehicles and area information including a point where the vehicle is positioned; accessing the database via the communication device to inquire, based on the information on the one or more other vehicles and the area information included in the received inquiry request, about whether there is the delinquent driving vehicle that has performed delinquent driving among the one or more other vehicles; transmitting an inquiry result from the database to the vehicle via the communication unit; receiving delinquent driving vehicle information generated by the vehicle in response to detection of a presence of the delinquent driving by the one or more other vehicles, the delinquent driving vehicle information including ID information of a delinquent driving vehicle that performs the delinquent driving and traveling trajectory information of the delinquent driving vehicle and the vehicle; and requesting the database that the delinquent driving vehicle information to be registered or updated.

Optional combinations of the above constituent elements and presentation of the present disclosure converted between methods, devices, systems, recording media, computer programs, and the like are effective as aspects of the present disclosure.

According to the present disclosure, whether delinquent driving such as pulling over is performed to an own vehicle during autonomous driving can be efficiently determined, and information on another vehicle that performs the delinquent driving can be generated as evidence and registered or updated in a predetermined database. Therefore, prevention of the delinquent driving can be effectively promoted.

### BRIEF DESCRIPTION OF DRAWINGS

FIG. 1 is a block diagram showing a system configuration example of a delinquent driving detection system including a vehicle on which a driving assistance apparatus according to a first embodiment is mounted.

FIG. 2 is a table showing a data configuration example of a delinquent driving table held in a delinquent driving database.

FIG. 3 is a flowchart showing an example of an operation procedure of a detection device mounted on the driving assistance apparatus according to the first embodiment.

FIG. 4 is a flowchart showing an example of an operation procedure of a delinquent driving detection device mounted on the driving assistance apparatus according to the first embodiment.

FIG. 5 is a flowchart showing an example of an operation procedure of a third party terminal.

FIG. 6 is a flowchart showing an example of an operation procedure of a cloud server.

FIG. 7 is a flowchart showing an example of an operation procedure of an external institution terminal.

FIG. 8 is a block diagram showing a system configuration example of the delinquent driving detection system including the vehicle on which the driving assistance apparatus according to a second embodiment is mounted.

FIG. 9 is a flowchart showing an example of an operation procedure of a detection device mounted on the driving assistance apparatus according to the second embodiment.

FIG. 10 is a flowchart showing an example of an operation procedure of the delinquent driving detection device mounted on the driving assistance apparatus according to the second embodiment.

FIG. 11 is a block diagram showing a system configuration example of the delinquent driving detection system including the vehicle on which the driving assistance apparatus according to a first modified example is mounted.

FIG. 12 is a block diagram showing a system configuration example of the delinquent driving detection system including the vehicle on which the driving assistance apparatus according to a second modified example is mounted.

FIG. 13 is a block diagram showing a system configuration example of the delinquent driving detection system including the vehicle on which the driving assistance apparatus according to a third modified example is mounted.

### DETAILED DESCRIPTION

Hereinafter, with reference to the accompanying drawings as appropriate, embodiments that specifically disclose a driving assistance apparatus, a vehicle, a delinquent driving detection system, and a server device according to the present disclosure will be described in detail. However, unnecessarily detailed description may be omitted. For example, a detailed description of a well-known matter or a repeated description of substantially the same configuration may be omitted. This is to avoid unnecessary redundancy in the following description and to facilitate understanding of those skilled in the art. It should be noted that the accompanying drawings and the following description are provided to enable those skilled in the art to fully understand the present disclosure, and are not intended to limit the claimed subject matter.

### First Embodiment

In a first embodiment, a vehicle 1 (hereinafter, may be referred to as “own vehicle”) on which a driving assistance apparatus 10 is mounted receives information (see below) on one or more other vehicles that travel in the vicinity of the own vehicle and area information of the own vehicle during autonomous driving. The vehicle 1 uses the information on other vehicles in the vicinity and the area information of the own vehicle so as to inquire of a cloud server 20 whether there is a delinquent driving vehicle that performs delinquent driving previously among other vehicles in the vicinity. The vehicle 1 detects, based on an inquiry result (see below) from the cloud server 20, whether delinquent driving by other vehicles in the vicinity of the own vehicle occurs. When the delinquent driving occurs, the vehicle 1 generates delinquent driving vehicle information including ID information (see below) of a delinquent driving vehicle that performs the delinquent driving and respective traveling trajectory information of the delinquent driving vehicle and the own vehicle. The vehicle 1 requests the cloud server 20 to register or update the generated delinquent driving vehicle information.

In the following description, the delinquent driving is malicious driving intentionally performed by another vehicle to the vehicle 1 with harassment or danger, and is, for example, an action such as pulling over by another vehicle, a lane change such as jumping forward, sudden braking in front, and tailgating driving from behind. The delinquent driving is not limited to these actions, and may also include a malicious action (delinquent action) performed by an obstacle (for example, a person) other than the vehicle.

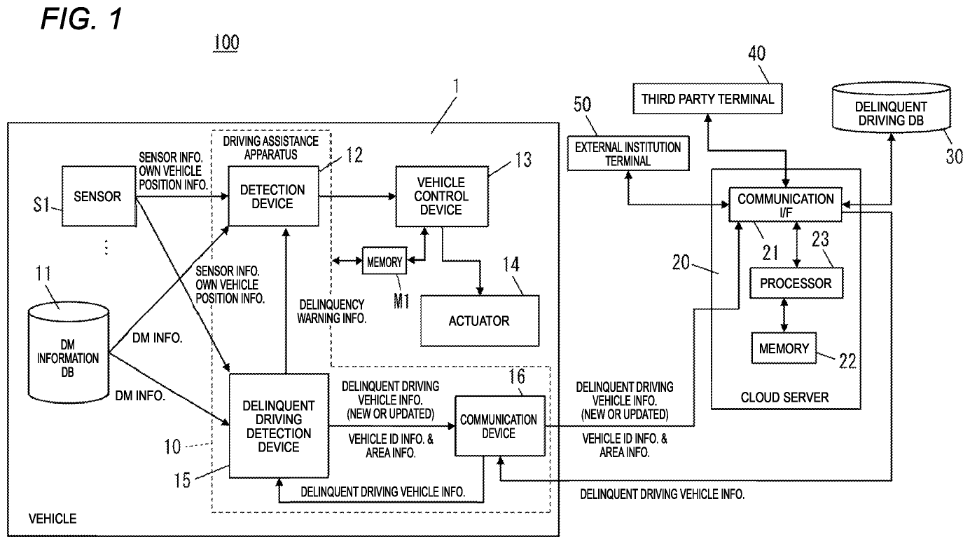

FIG. 1 is a block diagram showing a system configuration example of a delinquent driving detection system 100 including the vehicle 1 on which the driving assistance apparatus 10 according to the first embodiment is mounted. The delinquent driving detection system 100 includes the vehicle 1, the cloud server 20, a delinquent driving database 30, a third party terminal 40, and an external institution terminal 50. The vehicle 1 and the cloud server 20 are connected to communicate with each other via a network (not shown). The network is, for example, an Internet network or a wireless communication network such as a wireless local area network (LAN).

The delinquent driving database 30, the third party terminal 40, and the external institution terminal 50 are connected to communicate with each other via the cloud server 20. That is, the delinquent driving database 30 and the cloud server 20, the third party terminal 40 and the cloud server 20, and the external institution terminal 50 and the cloud server 20 are connected to communicate with each other via a network (not shown). Similarly, the network is, for example, an Internet network or a wireless communication network such as a wireless LAN.

The vehicle 1 includes a plurality of sensors S1, a memory M1, a dynamic map (DM) information database 11, the driving assistance apparatus 10, a vehicle control device 13, and an actuator 14. The vehicle 1 is a vehicle of the driving automation level 1 or higher, and in the following description, a vehicle of the driving automation level 3 is assumed in order to make the description easy to understand. The plurality of sensors S1, the memory M1, the DM information database 11, the driving assistance apparatus 10, the vehicle control device 13, and the actuator 14 are connected to one another so as to be able to input/output data or information via an in-vehicle network such as a controller area network (CAN).

The driving assistance apparatus 10 for controlling autonomous driving of the vehicle 1 is mounted on the vehicle 1. The driving assistance apparatus 10 is configured by using, for example, a single or a plurality of electronic control units (ECUs). The driving assistance apparatus 10 includes a detection device 12, a delinquent driving detection device 15, and a communication device 16. The communication device 16 may not be included in the driving assistance apparatus 10.

The driving assistance apparatus 10 operates in accordance with a program and data stored in the memory M1. Specifically, the driving assistance apparatus 10 generates a route toward a destination designated by an operation on a human machine interface (HMI, not shown) by a driver or the like, and assists execution of autonomous driving in accordance with the generated route based on output values (hereinafter, referred to as “sensor information”) detected by the plurality of sensors S1 in accordance with the route.

The driving assistance apparatus 10 outputs, to the vehicle control device 13, a control instruction for controlling operations of various control target equipment (for example, steering, an accelerator pedal, a brake, and a direction indicator) in the vehicle 1 during the autonomous driving in accordance with the route to the destination. The autonomous driving of the vehicle 1 includes a function of operating a brake so as to stop the vehicle 1 immediately before the vehicle 1 is about to collide with an obstacle (for example, another vehicle, a two-wheeled vehicle such as a motorcycle, a pedestrian, a guardrail, an electric pole, a pole, and facilities such as a store. The same applies hereinafter). Further, the autonomous driving of the vehicle 1 includes a function of following another vehicle that runs in front of the vehicle 1 while keeping a predetermined interval between the vehicle 1 and another vehicle. Further, although the autonomous driving of the vehicle 1 includes a function of controlling steering of the vehicle 1 so as not to protrude from a white line (that is, a lane), the above-described functions are examples of the autonomous driving and are not limited to these functions.

The plurality of sensors S1 detect a situation in the vicinity of the vehicle 1 and output information on a detection result (that is, the above-described sensor information) to the driving assistance apparatus 10. Traveling information that is an example of the sensor information is an advancing direction and a vehicle speed of the vehicle 1. Further, the traveling information may also include traveling information of one or more other vehicles that travel in the vicinity of the vehicle 1 (for example, a distance between the vehicle 1 and another vehicle, a direction in which another vehicle exists when viewed from the vehicle 1). The sensors S1 may include, for example, a camera, an around view camera, a radar, and a plurality of laser range finders. The sensor is not limited to any one of the camera, the around view camera, the radar, and the plurality of laser range finders, and may include, for example, a gyro sensor, an acceleration sensor, a geomagnetic sensor, an inclination sensor, an air temperature sensor, an atmospheric pressure sensor, a humidity sensor, and an illuminance sensor.

The camera that is an example of a sensor includes an image-capturing element such as a charge coupled device (CCD) or a complementary metal oxide semiconductor (CMOS). The camera is installed, for example, at a center of a front portion of a vehicle body of the vehicle 1 and captures an image of a front center range as a detection range. Specifically, the camera detects an obstacle (for example, another vehicle, a two-wheeled vehicle, a bicycle, and a pedestrian, and the same applies hereinafter) or the like that exists in front of the vehicle 1. The camera can execute an image processing using data of a captured image. The camera can detect a position and an advancing direction of the obstacle based on a position of the vehicle 1 by the image processing.

The around view camera that is an example of a sensor is configured by using a plurality of (for example, six in total, that is, two on a vehicle body front side, two on a vehicle body rear side, and two on vehicle body lateral sides) cameras respectively installed on the vehicle body front side, the vehicle body rear side, and the vehicle body lateral sides of the vehicle 1. The around view camera detects a pedestrian near the vehicle 1, a white line, another vehicle in an adjacent lane, and the like.

The radar that is an example of a sensor is configured by using a plurality of (for example, two) radars respectively installed on the vehicle body front side and the vehicle body rear side of the vehicle 1. The radar may be only installed on the vehicle body front side of the vehicle 1. The radar is configured by using, for example, a millimeter wave radar, a sonar radar, and light detection and ranging or laser imaging detection and ranging (LiDAR). The radar emits electromagnetic waves such as ultrasonic waves or millimeter waves while scanning in a limited angle range, receives reflected light thereof, and detects a time difference between a start time point of emitting and a reception time point of the reflected light, thereby detecting a distance between the own vehicle and the obstacle and a direction of the obstacle when viewed from the own vehicle.

The laser range finders that are examples of sensors are respectively installed on a vehicle body front right side, a vehicle body front left side, a vehicle body lateral right side, a vehicle body lateral left side, a vehicle body rear right side, and a vehicle body rear left side of the vehicle 1. The laser range finders detect obstacles (see above) or the like that exist on the front right side, the front left side, the lateral right side, the lateral left side, the rear right side, and the rear left side of the vehicle 1, respectively. Specifically, a laser range finder emits laser light while scanning in a predetermined wide-angle range, receives reflected light thereof, and detects a time difference between a start time point of emitting and a reception time point of the reflected light, thereby detecting a distance between the vehicle 1 and the obstacle and a direction of the obstacle when viewed from the vehicle 1.

A GPS receiver that is an example of a sensor receives a plurality of signals indicating time points and positions of GPS satellites (that is, three-dimensional coordinates) transmitted from a plurality of global positioning system (GPS) satellites, and calculates a position of the GPS receiver (that is, a current position of the vehicle 1) based on the plurality of received signals. The GPS receiver outputs information on the current position of the vehicle 1 (hereinafter, referred to as “own vehicle position information”) to the detection device 12 and the delinquent driving detection device 15 of the driving assistance apparatus 10.

The memory M1 is configured by using, for example, a random access memory (RAM) and a read only memory (ROM), and temporarily holds a program and data necessary for executing operations of the driving assistance apparatus 10 and the vehicle control device 13 and data or information generated during the operations. The RAM is a work memory used, for example, when the driving assistance apparatus 10 and the vehicle control device 13 operate. The ROM stores and holds in advance data and a program for controlling, for example, the driving assistance apparatus 10 and the vehicle control device 13.

The DM information database 11 is configured by using, for example, a hard disk drive (HDD) or a solid state drive (SSD), and holds a dynamic map that is dynamic road structure information necessary for implementing the autonomous driving of the vehicle 1. Dynamic map data is received by the detection device 12 and the delinquent driving detection device 15. The DM information database 11 may receive and update the dynamic map data periodically provided from a dynamic map providing server (not shown). In the accompanying drawings, the DM information database is abbreviated as “DM information DB” for convenience.

Here, the dynamic map is, for example, digital map data in which static high-precision three-dimensional map data is combined with information on a position where a dynamic change such as a traffic regulation due to traffic jam information of a road, an accident, or road construction occurs. The vehicle 1 can perform the autonomous driving while accurately estimating surrounding information of the vehicle 1 based on sensor information of the plurality of sensors S1 (for example, millimeter wave radars, ultrasonic wave sensors, and optical cameras) mounted on the vehicle 1, by using the dynamic map data that can be read from the DM information database 11.

The detection device 12 that is an example of a detector receives the sensor information detected by the plurality of sensors S1 and the own vehicle position information of the vehicle 1 calculated by the GPS receiver that is an example of a sensor S1. Further, the detection device 12 receives, from the DM information database 11, the dynamic map data necessary for the autonomous driving of the vehicle 1. The detection device 12 uses the received various pieces of information and data, so that a route when the vehicle 1 travels in the autonomous driving to the destination of the vehicle 1 is generated, and an instruction to execute the autonomous driving in accordance with the route is output to the vehicle control device 13.

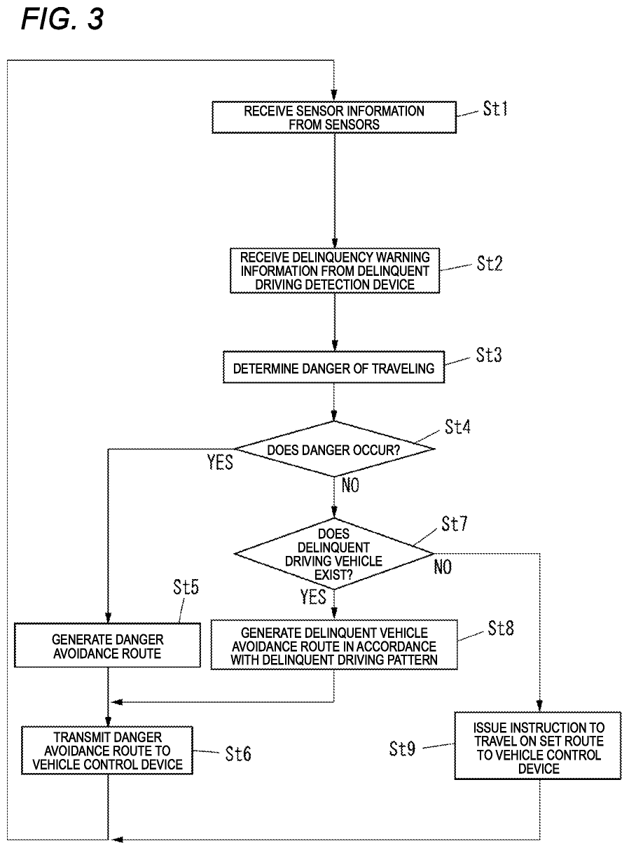

When receiving delinquency warning information (see below) from the delinquent driving detection device 15, the detection device 12 detects whether another vehicle that satisfies the delinquency warning information exists in the vicinity of the vehicle 1. When detecting that another vehicle that satisfies the delinquency warning information exists in the vicinity of the vehicle 1, the detection device 12 generates a delinquent vehicle avoidance route in accordance with information on a delinquent driving pattern and frequency included in the delinquency warning information, and causes the vehicle control device 13 to execute the autonomous driving such that a distance from a delinquent driving vehicle is increased to a certain extent. Details of an operation of the detection device 12 will be described later with reference to FIG. 3.

The delinquent driving detection device 15 that is an example of a delinquent driving detector receives the sensor information detected by the plurality of sensors S1 and the own vehicle position information of the vehicle 1 calculated by the GPS receiver that is an example of a sensor S1. Further, the delinquent driving detection device 15 receives, from the DM information database 11, the dynamic map data necessary for the autonomous driving of the vehicle 1. The delinquent driving detection device 15 recognizes information on one or more other vehicles that travel in the vicinity of the vehicle 1 during the autonomous driving (for example, vehicle ID information to be described later) and the area information of the own vehicle based on the sensor information detected by the plurality of sensors S1, the own vehicle position information, and the dynamic map data. The area information is information on a wide area including a point where the vehicle 1 (the own vehicle) is positioned.

The delinquent driving detection device 15 uses information on other vehicles in the vicinity (for example, the vehicle ID information to be described later) and the area information of the own vehicle so as to inquire of the cloud server 20 via the communication device 16 whether there is the delinquent driving vehicle that performs the delinquent driving previously among other vehicles in the vicinity. The delinquent driving detection device 15 detects whether the delinquent driving by other vehicles in the vicinity of the own vehicle occurs based on an inquiry result from the cloud server 20 (for example, the delinquent driving vehicle information obtained from the delinquent driving database 30 to be described later) and the sensor information obtained from the sensors S1.

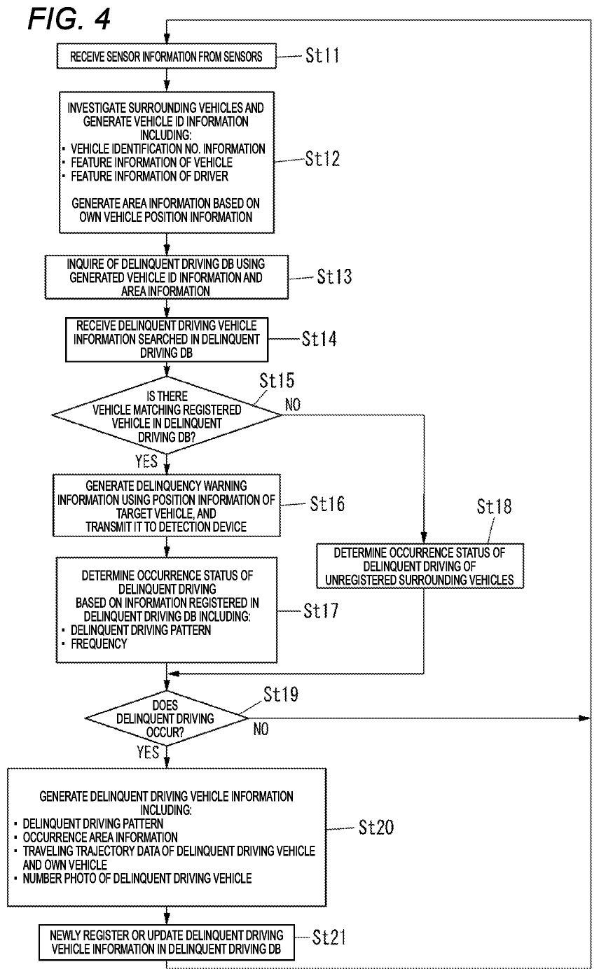

When the delinquent driving by other vehicles in the vicinity of the own vehicle occurs (that is, receive the delinquent driving), the delinquent driving detection device 15 generates the delinquent driving vehicle information (see below) including the ID information (that is, the vehicle ID information included in the delinquent driving vehicle information obtained from the delinquent driving database 30) of the delinquent driving vehicle that performs the delinquent driving and the traveling trajectory information (see below) of the delinquent driving vehicle and the own vehicle. The delinquent driving detection device 15 requests the cloud server 20 via the communication device 16 to register or update the generated delinquent driving vehicle information. Details of an operation of the delinquent driving detection device 15 will be described later with reference to FIG. 4.

The communication device 16 has a role serving as a communication interface with the cloud server 20, and is configured by using a communication circuit that enables wireless communication with the cloud server 20. The communication device 16 transmits to the cloud server 20 an inquiry request including the vehicle ID information and the area information of the own vehicle passed from the delinquent driving detection device 15. The communication device 16 passes the inquiry result from the cloud server 20 (that is, the delinquent driving vehicle information obtained from the delinquent driving database 30 to be described later) to the delinquent driving detection device 15.

The communication device 16 transmits to the cloud server 20 a request for registration or update of the delinquent driving vehicle information including the delinquent driving vehicle information (see below) generated by the delinquent driving detection device 15.

The vehicle control device 13 that is an example of a vehicle controller calculates, based on the instruction to execute the autonomous driving output from the detection device 12, a control value for controlling the control target equipment necessary for the autonomous driving, such as an accelerator throttle opening of the vehicle 1, a braking force of the vehicle 1, a steering angle, and a blinking timing of a winker. The vehicle control device 13 causes the actuator 14 to execute an operation of the control target equipment mounted on the vehicle 1 in accordance with the calculated control value. The control value is calculated such that the vehicle 1 travels in accordance with the route generated by, for example, the detection device 12 included in the driving assistance apparatus 10. The route is calculated and generated by the detection device 12 and is input to the vehicle control device 13. The vehicle control device 13 transmits the calculated control value to the actuator 14 (that is, a steering actuator, an accelerator pedal actuator, a brake actuator, a winker blinking controller) for driving the control target equipment (for example, the steering, the accelerator pedal, the brake, and the direction indicator).

The control target equipment is equipment provided in the vehicle 1 and receives control of an operation by the vehicle control device 13 during the autonomous driving of the vehicle 1. An operation of the control target equipment is controlled by the actuator 14.

The steering actuator is connected to the steering disposed in the vehicle 1, and controls an operation of the steering (in other words, maintaining or changing an advancing direction of the vehicle 1) during the autonomous driving in accordance with a control signal of the steering (not shown) input from the vehicle control device 13.

The accelerator pedal actuator is connected to the accelerator pedal disposed in the vehicle 1, and controls an operation of the accelerator pedal (in other words, maintaining, increasing, or decreasing a vehicle speed of the vehicle 1) during the autonomous driving in accordance with a control signal of the accelerator pedal (not shown) input from the vehicle control device 13.

The brake actuator is connected to a brake mechanism (that is, the brake) disposed in the vehicle 1, and controls an operation of the brake (in other words, maintaining or changing braking as the vehicle 1 advances) during the autonomous driving in accordance with a control signal of the brake (not shown) input from the vehicle control device 13.

The winker blinking controller is connected to a blinking mechanism (hereinafter, abbreviated as “winker”) of the direction indicator disposed in the vehicle 1, and controls an operation of the winker (in other words, blinking of the winker for notifying that the vehicle 1 turns left or turns right) during the autonomous driving in accordance with a control signal of the winker (not shown) input from the vehicle control device 13.

The cloud server 20 that is an example of the server device is, for example, a server device constructed by a system administrator of the delinquent driving detection system 100, and includes at least a communication interface 21, a memory 22, and a processor 23. The communication interface 21, the memory 22, and the processor 23 are connected to one another via an internal bus so as to be able to input/output data or information.

The communication interface 21 that is an example of a communication device is configured by using a communication circuit that can communicate data or information with external apparatuses (for example, the vehicle 1, the delinquent driving database 30, the third party terminal 40, and the external institution terminal 50) connected via the network (not shown). The communication interface 21 receives the data or the information transmitted from the external apparatuses and outputs the received data or information to the memory 22 or the processor 23, or transmits the data or information input from the processor 23 to the external apparatuses (see above). In the accompanying drawings, the communication interface is abbreviated as “communication I/F” for convenience.

The memory 22 is configured by using, for example, a RAM and a ROM, and temporarily holds a program and data necessary for executing an operation of the cloud server 20 and data or information generated during the operation. The RAM is a work memory used, for example, when the cloud server 20 operates. The ROM stores and holds in advance data and a program for controlling, for example, the cloud server 20.

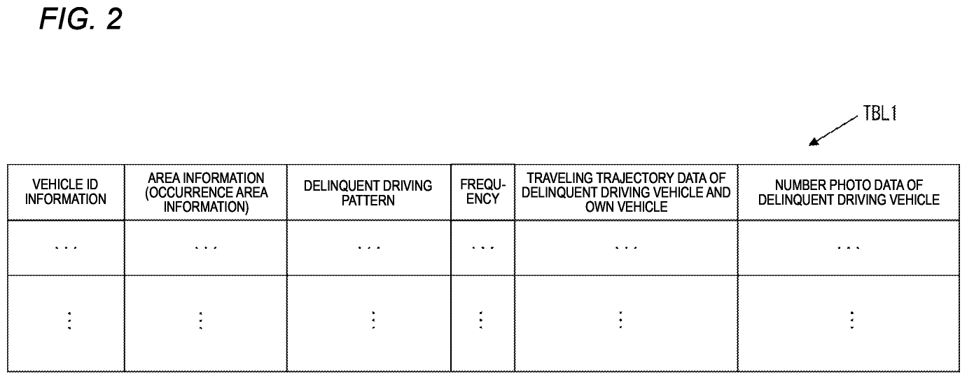

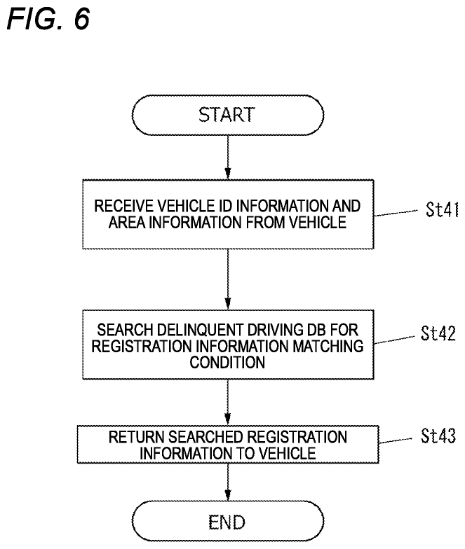

The processor 23 is configured by using, for example, a central processing unit (CPU), a micro processing unit (MPU), a digital signal processor (DSP), or a field-programmable gate array (FPGA). The processor 23 functions as a controller of the cloud server 20, and performs a control processing for generally controlling operations of units of the cloud server 20, an input/output processing of data among the units of the cloud server 20, a data computation (calculation) processing, and a data storage processing. The processor 23 operates in accordance with the program and data stored in the memory 22. The processor 23 accesses the delinquent driving database 30 (see FIG. 2), and generates data or information as an inquiry result regarding whether there is another vehicle that performs the delinquent driving previously among other vehicles in the vicinity of the vehicle 1, based on an inquiry request including the vehicle ID information and the area information of the own vehicle transmitted from the vehicle 1. The processor 23 transmits (responds) the delinquent driving vehicle information (see below) obtained as an inquiry result of the delinquent driving database 30 to the vehicle 1 via the communication interface 21. Details of an operation of the cloud server 20 will be described later with reference to FIG. 6.

The delinquent driving database 30 that is an example of an external database is a database that holds a delinquent driving table TBL1 in which feature information of the delinquent driving vehicle that performs the delinquent driving previously is associated with the vehicle ID information with which the delinquent driving vehicle can be identified (see FIG. 2). Here, the vehicle ID information that is an example of ID information is information with which a vehicle can be identified, and is specifically vehicle identification number (No.) information, feature information of a vehicle (for example, information on a vehicle type and a vehicle color), and feature information of a driver (for example, information on a face and an appearance of the driver). The delinquent driving database 30 is connected to allow access from any one of the cloud server 20, the third party terminal 40, and the external institution terminal 50. In other words, a content of the delinquent driving table TBL1 held in the delinquent driving database 30 is widely published. The delinquent driving database 30 may be provided in the cloud server 20. In the accompanying drawings, the delinquent driving database is abbreviated as “delinquent driving DB” for convenience.

FIG. 2 is a table showing a data configuration example of the delinquent driving table TBL1 held in the delinquent driving database 30. As shown in FIG. 2, the delinquent driving table TBL1 holds area information (that is, information on an area where the delinquent driving occurs), a delinquent driving pattern, a frequency, traveling trajectory data of the delinquent driving vehicle and the vehicle 1 (the own vehicle), and photo data taken with the license number of the delinquent driving vehicle in association with vehicle ID information (see above) that is identification information of one delinquent driving vehicle.

The delinquent driving pattern indicates a type of the delinquent driving performed by the delinquent driving vehicle specified by the vehicle ID information, and is, for example, the pulling over, the lane change such as jumping forward, the sudden braking in front, and the tailgating driving from behind.

The frequency indicates a frequency of the delinquent driving performed by the delinquent driving vehicle specified by the vehicle ID information.

The traveling trajectory data of the delinquent driving vehicle and the vehicle 1 (own vehicle) is data indicating respective trajectories of traveling routes of the delinquent driving vehicle and the vehicle 1 in a predetermined period that includes a time point at which it is detected that the delinquent driving vehicle performs the delinquent driving to the vehicle 1. Further, the traveling trajectory data of the delinquent driving vehicle and the vehicle 1 (own vehicle) may be video data in a predetermined period including the time point at which the delinquent driving vehicle performs the delinquent driving to the vehicle 1.

The number photo data of the delinquent driving vehicle is data of a captured image (that is, a photo) in which a number plate of another vehicle (that is, the delinquent driving vehicle) that performs the delinquent driving to the vehicle 1 is captured by a sensor S1 of the vehicle 1 (for example, a camera).

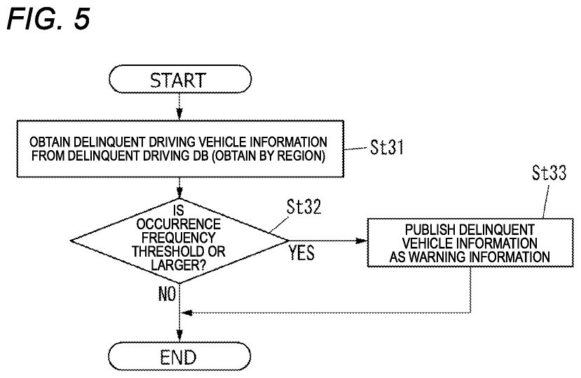

The third party terminal 40 is, for example, a computer (for example, a personal computer (PC)) disposed in a building of a third-party institution such as an administrative local government or a traffic safety association, and can access the cloud server 20 and the delinquent driving database 30. In FIG. 1, although the number of arrangement of the third party terminal 40 is one, the third party terminal 40 may be disposed for each third-party institution. The third party terminal 40 accesses the delinquent driving database 30 so as to periodically obtain delinquent driving vehicle information of corresponding area information (that is, a region where the third-party institution is positioned), and determines whether a frequency of the delinquent driving of the delinquent driving vehicle specified by the delinquent driving vehicle information is equal to or larger than a threshold. Details of an operation of the third party terminal 40 will be described later with reference to FIG. 5.

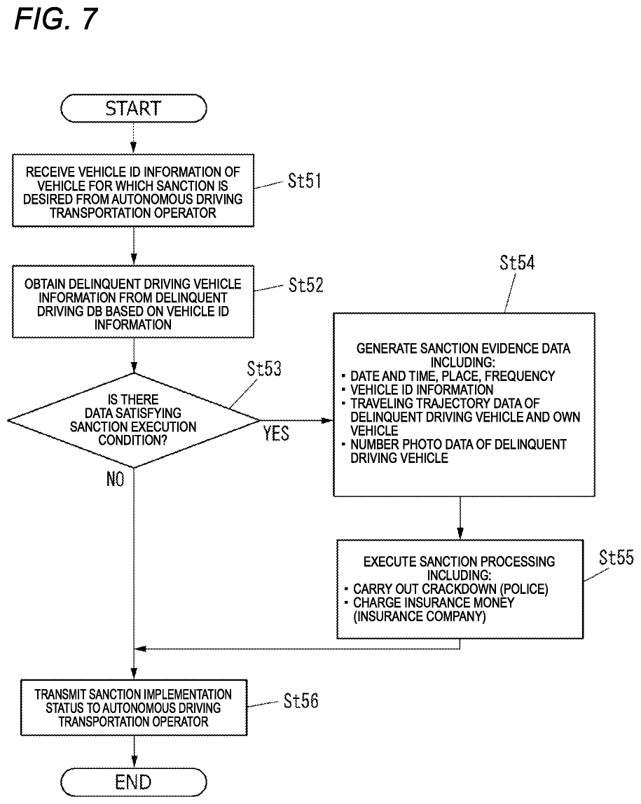

The external institution terminal 50 is, for example, a computer (for example, a PC) disposed in a building of an external institution such as a police station or an automobile insurance company, and can access the cloud server 20 and the delinquent driving database 30. In FIG. 1, although the number of arrangement of the external institution terminal 50 is one, the external institution terminal 50 may be disposed for each external institution. When receiving the vehicle ID information of the delinquent driving vehicle desired to be sanctioned from a terminal (not shown) of an autonomous driving transportation operator (for example, an operator that uses an autonomous vehicle such as the vehicle 1 for services such as a taxi, a bus, and car sharing), the external institution terminal 50 obtains corresponding delinquent driving vehicle information from the delinquent driving database 30 based on the vehicle ID information. When the obtained delinquent driving vehicle information satisfies a predetermined sanction execution condition, the external institution terminal 50 prompts (for example, pop-up displays a predetermined message) a staff member of the external institution (see above) to execute a predetermined sanction measure. Details of an operation of the external institution terminal 50 will be described later with reference to FIG. 7.

Next, an operation procedure of the detection device 12 of the driving assistance apparatus 10 according to the first embodiment will be described with reference to FIG. 3. FIG. 3 is a flowchart showing an example of the operation procedure of the detection device 12 mounted on the driving assistance apparatus 10 according to the first embodiment. As a premise of the description of FIG. 3, the vehicle 1 is being autonomously driven toward a destination designated by an operation of a user such as a driver.

In FIG. 3, the detection device 12 constantly receives the sensor information from the plurality of sensors S1 (St1). When the delinquent driving detection device 15 detects that any one of one or more other vehicles that travel in the vicinity of the vehicle 1 (the own vehicle) in the autonomous driving is the delinquent driving vehicle that performs the delinquent driving previously, the detection device 12 receives the delinquency warning information from the delinquent driving detection device 15 (St2). The delinquency warning information is information indicating a feature of the delinquent driving vehicle when any one of one or more other vehicles that travel in the vicinity of the vehicle 1 (the own vehicle) in the autonomous driving is the delinquent driving vehicle that performs the delinquent driving previously. Specifically, the delinquency warning information includes vehicle ID information, delinquent driving pattern information, frequency information, and position information of a vehicle (that is, another vehicle) specified by the vehicle ID information. Accordingly, the delinquency warning information from the delinquent driving detection device 15 is received, so that the detection device 12 can be alerted that the delinquent driving vehicle that performs the delinquent driving previously exists in the vicinity of the vehicle 1.

The processing of step St2 may be omitted when the delinquent driving detection device 15 detects that any one of one or more other vehicles that travel in the vicinity of the vehicle 1 (own vehicle) is not the delinquent driving vehicle that performs the delinquent driving previously.

The detection device 12 determines, based on the sensor information from the plurality of sensors S1 and dynamic map data from the DM information database 11, whether there is a danger (for example, another vehicle entering a traveling region of the vehicle 1 such that a collision with another vehicle occurs) to the vehicle 1 that is traveling by the autonomous driving (St3).

When determining that there is the danger to the vehicle 1 that is traveling by the autonomous driving (St4, YES), the detection device 12 generates a route for avoiding a danger with other vehicles in the vicinity (a danger avoidance route) (St5). The detection device 12 outputs the danger avoidance route information generated in step St5 to the vehicle control device 13 (St6), and causes the vehicle control device 13 to execute the autonomous driving in accordance with the danger avoidance route. After step St6, the processing of the detection device 12 returns to step St1.

On the other hand, when determining that there is no danger to the vehicle 1 that is traveling by the autonomous driving (St4, NO), the detection device 12 determines whether another vehicle that satisfies the delinquency warning information received in step St2 exists in the vicinity based on the sensor information from the plurality of sensors S1 (St7).

When determining that another vehicle that satisfies the delinquency warning information exists in the vicinity (St7, YES), the detection device 12 generates a route for avoiding another vehicle in the vicinity (a delinquent vehicle avoidance route) in accordance with at least the delinquent driving pattern between the delinquent driving pattern and the frequency included in the delinquency warning information (St8). Accordingly, the detection device 12 can actively avoid another vehicle (that is, the delinquent driving vehicle that performs the delinquent driving previously) in the vicinity of the vehicle 1 (the own vehicle) and implement safe traveling of the vehicle 1 by the autonomous driving.

For example, when another vehicle in the vicinity pulls over, which is a delinquent driving pattern, the detection device 12 can generate a delinquent vehicle avoidance route for changing a lane. Further, for example, when another vehicle in the vicinity suddenly brakes, which is a delinquent driving pattern, the detection device 12 can generate a delinquent vehicle avoidance route for ensuring a predetermined distance from another vehicle. Further, for example, when another vehicle in the vicinity performs tailgating driving, which is a delinquent driving pattern, the detection device 12 can generate a delinquent vehicle avoidance route for passing such as decelerating, stopping at a road shoulder, and changing a route.

When the frequency included in the delinquency warning information is larger than a predetermined threshold, the detection device 12 can also generate a delinquent vehicle avoidance route that is more aggressive than the above-described delinquent vehicle avoidance routes and on which an avoidance measure has been taken in advance. For example, when another vehicle in the vicinity frequently pulls over, which is a delinquent driving pattern, the detection device 12 can generate a delinquent vehicle avoidance route for changing a lane such that the vehicle 1 is immediately separated from another vehicle. Further, for example, when another vehicle in the vicinity frequently suddenly brakes, which is a delinquent driving pattern, the detection device 12 can generate a delinquent vehicle avoidance route for ensuring a predetermined distance further apart from another vehicle. Further, for example, when another vehicle in the vicinity frequently performs the tailgating driving, which is a delinquent driving pattern, the detection device 12 can generate a delinquent vehicle avoidance route for rapidly passing, such as decelerating, stopping at a road shoulder, and changing a route.

Only when it is determined that a frequency of delinquent driving (for example, the total number of executions of the delinquent driving so far) of another vehicle (specifically, another vehicle specified by delinquent driving information received in step St2) in the vicinity of the vehicle 1 (the own vehicle) is equal to or larger than a predetermined value (for example, 3), the detection device 12 may generate a route for avoiding corresponding another vehicle (a delinquent vehicle avoidance route) (St8). Here, the predetermined value is set to 3 or more, since the delinquent driving vehicle information (see FIG. 2) is automatically registered in the delinquent driving database 30 in accordance with information mainly including the sensor information, misidentification of the delinquency warning information is reduced by excluding a case where, for example, a driver of another vehicle does not intentionally perform the delinquent driving and consequently performs the delinquent driving in consideration of a traffic situation or the like. Accordingly, the detection device 12 can early and easily select another vehicle that is likely to perform the delinquent driving (that is, another vehicle that performs the delinquent driving a number of times equal to or larger than a predetermined value previously) among other vehicles in the vicinity of the vehicle 1 (the own vehicle), and can assist in implementing safer autonomous driving of the vehicle 1 (the own vehicle).

Only when it is determined that the frequency of the delinquent driving (for example, the total number of executions of the delinquent driving so far) of another vehicle (specifically, another vehicle specified by the delinquent driving information received in step St2) in the vicinity of the vehicle 1 (the own vehicle) is equal to or larger than the predetermined value (for example, 3), the detection device 12 may generate a route for avoiding another vehicle (a delinquent vehicle avoidance route) after considering a corresponding content of a delinquent driving pattern of another vehicle (St8). Here, the predetermined value is set to 3 or more for the same reason as described above. Accordingly, the detection device 12 can early and easily select another vehicle that is likely to perform the delinquent driving (that is, another vehicle that performs the delinquent driving a number of times equal to or larger than a predetermined value previously) among other vehicles in the vicinity of the vehicle 1 (the own vehicle), and can further assist in implementing safer autonomous driving of the vehicle 1 (the own vehicle) such that another vehicle can prevent delinquent driving of a delinquent driving pattern that has been performed previously.

On the other hand, when determining that another vehicle that satisfies the delinquency warning information does not exist in the vicinity (St7, NO), the detection device 12 causes the vehicle control device 13 to execute autonomous driving using a currently set route (St9).

Next, an operation procedure of the delinquent driving detection device 15 of the driving assistance apparatus 10 according to the first embodiment will be described with reference to FIG. 4. FIG. 4 is a flowchart showing an example of the operation procedure of the delinquent driving detection device 15 mounted on the driving assistance apparatus 10 according to the first embodiment. As a premise of the description of FIG. 4, the vehicle 1 is being autonomously driven toward the destination designated by the operation of the user such as a driver.

In FIG. 4, the delinquent driving detection device 15 constantly or periodically receives the sensor information from the plurality of sensors S1 (St11). The delinquent driving detection device 15 uses the sensor information obtained in step St11 so as to generate respective vehicle ID information (see above) of one or more other vehicles in the vicinity of the vehicle 1 (the own vehicle), and generate the area information based on the position information of the vehicle 1 (the own vehicle) (St12). For example, if the position information of the vehicle 1 is “CC town, BB district, AA city”, the delinquent driving detection device 15 generates the area information that is the wide-area “AA city” including the “CC town”. The delinquent driving detection device 15 generates the wide area information from the position information of the vehicle 1 and uses the area information for an inquiry request to the cloud server 20. Accordingly, the cloud server 20 can rapidly make an inquiry specific to a current area where the vehicle 1 travels.

The delinquent driving detection device 15 generates an inquiry request including the vehicle ID information and the area information generated in step St12 in order to inquire of the cloud server 20 whether the delinquent driving vehicle that performs the delinquent driving previously exists among one or more other vehicles in the vicinity of the vehicle 1 (the own vehicle). The delinquent driving detection device 15 transmits the generated inquiry request to the cloud server 20 via the communication device 16 (St13).

In response to the inquiry request generated by the delinquent driving detection device 15, the cloud server 20 searches the delinquent driving database 30 so as to determine whether another vehicle that satisfies the vehicle ID information in the area information included in the inquiry request performs the delinquent driving previously. The cloud server 20 transmits a search result (that is, an inquiry result) of the delinquent driving database 30 to the vehicle 1. The inquiry result includes, for example, corresponding vehicle ID information of the delinquent driving database 30 shown in FIG. 2 and various pieces of information (for example, information on the delinquent driving pattern and the frequency) associated with the vehicle ID information.

The delinquent driving detection device 15 receives, via the communication device 16, the inquiry result of the delinquent driving database 30 transmitted from the cloud server 20 (St14). The delinquent driving detection device 15 determines whether the vehicle ID information generated in step St12 is registered in the delinquent driving database 30 (in other words, whether another vehicle in the vicinity of the vehicle 1 performs the delinquent driving previously) based on the inquiry result of the delinquent driving database 30 (St15). Accordingly, the delinquent driving detection device 15 easily predicts a type of the delinquent driving, such as decelerating or pulling over, in consideration of the inquiry result (for example, the information on the delinquent driving pattern and the frequency) of the delinquent driving database 30, and thus can rapidly determine whether the delinquent driving occurs.

When determining that the vehicle ID information is registered in the delinquent driving database 30 (St15, YES), the delinquent driving detection device 15 uses position information (in other words, the position information of the vehicle 1) of a target vehicle (that is, another vehicle whose vehicle ID information is registered in the delinquent driving database 30 and that is traveling in the vicinity of the vehicle 1) so as to generate the delinquency warning information (see above) (St16). The delinquent driving detection device 15 sends the generated delinquency warning information to the detection device 12 (St16).

The delinquent driving detection device 15, after step St16, determines an occurrence status of delinquent driving (in other words, whether the delinquent driving occurs) by one or more other vehicles in the vicinity of the vehicle 1 (own vehicle) based on the information on the delinquent driving pattern and the frequency included in the inquiry result of the delinquent driving database 30 and the sensor information obtained in step St11 (St17). Accordingly, the delinquent driving detection device 15 can rapidly determine whether delinquent driving by other vehicles occurs while monitoring one or more other vehicles in the vicinity, in consideration of the information on the delinquent driving pattern and the frequency.

On the other hand, when determining that the vehicle ID information is not registered in the delinquent driving database 30 (St15, NO), the delinquent driving detection device 15 determines an occurrence status of delinquent driving (in other words, whether the delinquent driving occurs) by one or more other vehicles (that is, other vehicles that do not perform the delinquent driving previously) in the vicinity of the vehicle 1 (the own vehicle) based on the sensor information obtained in step St11 (St18). After step St17 or step St18, when the delinquent driving by one or more other vehicles in the vicinity of the vehicle 1 does not occur (St19, NO), the processing of the delinquent driving detection device 15 returns to step St11.

On the other hand, when determining that the delinquent driving by one or more other vehicles in the vicinity of the vehicle 1 (the own vehicle) occurs after step St17 or step St18 (St19, YES), the delinquent driving detection device 15 generates delinquent driving vehicle information corresponding to another vehicle that performs the delinquent driving (St20). The delinquent driving vehicle information generated in step St20 includes, for example, information on an area where the delinquent driving occurs, delinquent driving pattern information, data indicating respective traveling trajectories of the delinquent driving vehicle (that is, another vehicle that performs the delinquent driving to the vehicle 1) and the vehicle 1 (the own vehicle), and photo data obtained by capturing an image of a number plate of the delinquent driving vehicle (that is, captured image data). The delinquent driving vehicle information is used as evidence information used when an external institution (see above) such as a police station or an automobile insurance company determines whether there is a sanction.

The delinquent driving detection device 15 generates a registration request including the delinquent driving vehicle information generated in step St20 and the vehicle ID information of the delinquent driving vehicle that performs the delinquent driving (St21), and transmits the registration request to the cloud server 20 via the communication device 16. Accordingly, in accordance with the registration request transmitted from the vehicle 1, the cloud server 20 newly registers or updates, in the delinquent driving database 30, the vehicle ID information and the delinquent driving vehicle information corresponding to the vehicle ID information that are included in the registration request. After the processing of step St 21, the processing of the delinquent driving detection device 15 returns to step St11.

Next, an operation procedure of the third party terminal 40 according to the first embodiment will be described with reference to FIG. 5. FIG. 5 is a flowchart showing an example of the operation procedure of the third party terminal 40. A processing shown in FIG. 5 is periodically executed.

In FIG. 5, the third party terminal 40 accesses the delinquent driving database 30 via the cloud server 20, and obtains the delinquent driving vehicle information registered or updated since previous access time from the delinquent driving database 30 (St31). As described above, since the third-party institution is disposed for each region, the third party terminal 40 can easily obtain, from the delinquent driving database 30 in which a huge amount of data or information is registered, delinquent driving vehicle information including a corresponding district or region as the area information.

The third party terminal 40 individually determines, for one or more pieces of delinquent driving vehicle information obtained in step St41, whether a frequency included in delinquent driving vehicle information (that is, a frequency of occurrence of the delinquent driving) is equal to or larger than a predetermined threshold (St32). When a frequency included in each delinquent driving vehicle information (that is, a frequency of occurrence of the delinquent driving) is not larger than the predetermined threshold (St32, NO), the processing of the third party terminal 40 ends.

On the other hand, when determining that the frequency included in each delinquent driving vehicle information is equal to or larger than the predetermined threshold (St32, YES), the third party terminal 40 accesses the delinquent driving database 30 via the cloud server 20 so as to obtain the delinquent driving vehicle information, and publishes, on a homepage (not shown) of the third-party institution or the like, information obtained by removing personal information from the obtained corresponding delinquent driving vehicle information as the warning information (St33). Therefore, information on an area where the delinquent driving frequently occurs, a delinquent driving pattern in the area, and a feature of a vehicle that performs the delinquent driving are widely published on the homepage of the third-party institution, and an unspecified number of drivers or the like are noticed. Accordingly, it is expected that the delinquent driving is effectively prevented. When there is delinquent driving vehicle information in which a frequency of occurrence of the delinquent driving is larger than a predetermined threshold (for example, the number of times), the third party terminal 40 publishes information obtained by removing information belonging to personal information (specifically, the traveling trajectory data of the delinquent driving vehicle and the own vehicle, and the number photo data of the delinquent driving vehicle shown in FIG. 2) from the delinquent driving vehicle information, such that the information can be accessed from an unspecified number of PCs or the like on a homepage of a third-party institution corresponding to the third party terminal 40. Accordingly, information on a feature of a delinquent driving vehicle for which a warning is given is published by the third party terminal 40 on the homepage of the third-party institution or the like that is widely and commonly published, so that it is expected that the delinquent driving is effectively prevented.

The processing of the third party terminal 40 shown in FIG. 5 is similarly executed in embodiments and modifications to be described later.

Next, an operation procedure of the cloud server 20 according to the first embodiment will be described with reference to FIG. 6. FIG. 6 is a flowchart showing an example of the operation procedure of the cloud server 20.

In FIG. 6, the cloud server 20 receives an inquiry request including the vehicle ID information and the area information from the vehicle 1 (St41). In accordance with the inquiry request generated by the delinquent driving detection device 15, the cloud server 20 searches the delinquent driving database 30 so as to determine whether there is registration information that matches the inquiry request (that is, whether another vehicle that satisfies the vehicle ID information in the area information included in the inquiry request performs the delinquent driving previously) (St42). Since the area information is included in the inquiry request from the vehicle 1, the cloud server 20 can easily search for delinquent driving vehicle information including corresponding area information from the delinquent driving database 30 in which a huge amount of data or information is registered, and can obtain a search result.

The cloud server 20 transmits the search result (that is, the inquiry result) of the delinquent driving database 30 to the vehicle 1 (St43). The inquiry result includes, for example, corresponding vehicle ID information of the delinquent driving database 30 shown in FIG. 2 and various pieces of information (for example, information on the delinquent driving pattern and the frequency) associated with the vehicle ID information.

Next, an operation procedure of the external institution terminal 50 according to the first embodiment will be described with reference to FIG. 7. FIG. 7 is a flowchart showing an example of the operation procedure of the external institution terminal 50.

In FIG. 7, the external institution terminal 50 receives vehicle ID information of a delinquent driving vehicle for which a sanction is desired and that is transmitted from a terminal (not shown) such as a PC disposed in a business office of an autonomous driving transportation operator (for example, an operator that uses an autonomous vehicle such as the vehicle 1 for services such as a taxis, a bus, and car sharing) (St51). Based on the vehicle ID information received in step St51, the external institution terminal 50 accesses the delinquent driving database 30 via the cloud server 20, and obtains delinquent driving vehicle information corresponding to the vehicle ID information from the delinquent driving database 30 (St52).

The external institution terminal 50 holds a sanction execution condition (for example, condition information for identifying a habitual offender who performs malicious delinquent driving as defined by a combination of a delinquent driving pattern and a frequency) specific to each external institution, and determines whether the delinquent driving vehicle information obtained in step St52 satisfies the sanction execution condition (St53). When it is determined that the delinquent driving vehicle information obtained in step St52 does not satisfy the sanction execution condition (St53, NO), the processing of the external institution terminal 50 proceeds to step St56.

On the other hand, when determining that the delinquent driving vehicle information obtained in step St52 satisfies the sanction execution condition (St53, YES), the external institution terminal 50 generates sanction evidence data (St54). The sanction evidence data generated in step St54 includes, for example, data indicating date and time when the delinquent driving occurs, a place where the delinquent driving occurs, the frequency, and the respective traveling trajectories of the delinquent driving vehicle and the vehicle 1 (own vehicle), and the photo data obtained by capturing the image of the number plate of the delinquent driving vehicle (that is, the captured image data). After generating the sanction evidence data in step St54, the external institution terminal 50 prompts a staff member of an external institution to execute the following predetermined sanction processing (St55).

For example, when the external institution is a police station, a police officer carries out a crackdown on a driver who owns a delinquent driving vehicle. Further, for example, when the external institution is an automobile insurance company, a staff member of the automobile insurance company charges predetermined insurance money to the driver who owns the delinquent driving vehicle. Accordingly, since the sanction evidence data is generated in step St54, the external institution terminal 50 can smoothly prompt the police officer, the staff member, or the like to execute an effective sanction measure using the sanction evidence data.

The external institution terminal 50 generates sanction implementation status data based on a processing result of the sanction executed in step St55, and transmits the generated sanction implementation status data to a terminal (not shown) of an autonomous driving transportation operator (St56). When there is no data that satisfies the sanction execution condition, the external institution terminal 50 generates sanction implementation status data indicating that fact and transmits the generated sanction implementation status data to the terminal (not shown) of the autonomous driving transportation operator (St56).

As described above, the driving assistance apparatus 10 or the vehicle 1 according to the first embodiment includes the detection device 12 that determines whether there is a change in a route during autonomous driving based on sensor information of the plurality of sensors S1 provided by the vehicle 1, and that outputs an instruction to execute the autonomous driving in accordance with a determination result thereof to the vehicle control device 13. The driving assistance apparatus 10 or the vehicle 1 includes the delinquent driving detection device 15 that inquires of the delinquent driving database 30 whether there is a delinquent driving vehicle that performs delinquent driving among other vehicles by using information on one or more other vehicles in the vicinity of the vehicle 1 and area information of the vehicle 1 in the autonomous driving, and that detects whether delinquent driving by other vehicles occurs based on an inquiry result from the delinquent driving database 30. When the delinquent driving occurs, the driving assistance apparatus 10 or the vehicle 1 generates delinquent driving vehicle information including ID information of a delinquent driving vehicle that performs the delinquent driving and respective traveling trajectory information of the delinquent driving vehicle and the vehicle 1, and requests the delinquent driving vehicle information to be registered or updated in the delinquent driving database 30.

Accordingly, the vehicle 1 can efficiently determine whether one or more other vehicles that travel in the vicinity of the vehicle 1 (own vehicle) perform the delinquent driving, such as pulling over, to the vehicle 1 during the autonomous driving. Further, the vehicle 1 can generate information on another vehicle that performs the delinquent driving as sanction evidence data and newly register or update the generated information in the widely and commonly published delinquent driving database 30, and thus can effectively promote prevention of the delinquent driving by other vehicles.

The inquiry result from the delinquent driving database 30 includes information on a pattern and a frequency of delinquent driving of another vehicle that performs the delinquent driving previously. The delinquent driving detection device 15 detects whether the delinquent driving by other vehicles occurs based on the information on the pattern and the frequency of the delinquent driving. Accordingly, the vehicle 1 easily predicts a type of the delinquent driving, such as decelerating or pulling over, in consideration of the inquiry result (for example, the information on the delinquent driving pattern and the frequency) of the delinquent driving database 30, and thus can rapidly determine whether the delinquent driving occurs.

The delinquent driving detection device 15 uses the inquiry result from the delinquent driving database 30 so as to generate delinquency warning information indicating a feature of the delinquent driving vehicle and send the generated delinquency warning information to the detection device 12. When detecting at least one of other vehicles that satisfy the delinquency warning information, the detection device 12 generates a delinquency avoidance route in accordance with the delinquency warning information and outputs the generated delinquency avoidance route to the vehicle control device 13. Accordingly, the vehicle 1 can travel based on safe autonomous driving of the vehicle 1 by actively avoiding other vehicles (that is, a delinquent driving vehicle that performs the delinquent driving previously) in the vicinity of the vehicle 1 (the own vehicle).

The delinquency warning information includes the delinquent driving pattern information. The detection device 12 generates a delinquency avoidance route in accordance with a delinquent driving pattern. Accordingly, since the vehicle 1 can generate a route that can avoid a collision even when delinquent driving that has been performed previously is performed in consideration of a past type of delinquent driving by other vehicles that travel in the vicinity of the vehicle 1, the vehicle 1 can safely continue the autonomous driving.

The delinquency warning information includes the information on the delinquent driving pattern and the frequency of the delinquent driving. The detection device 12 generates the delinquency avoidance route in accordance with the delinquent driving pattern and the frequency of the delinquent driving. Accordingly, since the vehicle 1 can generate a route such that a collision can be avoided in advance even when the delinquent driving that has been performed previously is frequently performed in consideration of both the past type of the delinquent driving by other vehicles that travel in the vicinity of the vehicle 1 and a frequency thereof, the vehicle 1 can safely continue the autonomous driving.

The delinquent driving detection device 15 receives identification number information of other vehicles (for example, vehicle identification number information) and feature information of other vehicles and drivers, which are included in the sensor information from the plurality of sensors S1, as information on other vehicles. Accordingly, the vehicle 1 can always receive the latest sensor information during the autonomous driving, and can easily search the delinquent driving database 30 using the information, and thus can highly accurately detect whether there is the delinquent driving.

The cloud server 20 according to the first embodiment is connected to access the delinquent driving database 30 that holds information on a delinquent driving vehicle (that is, delinquent driving vehicle information) that performs the delinquent driving previously. The cloud server 20 receives an inquiry request that includes the information on one or more other vehicles in the vicinity of the vehicle 1 and the area information of the vehicle 1 during the autonomous driving, and that is for inquiring whether there is the delinquent driving vehicle that performs the delinquent driving among other vehicles. The cloud server 20 makes, based on the information on other vehicles and the area information of the vehicle 1 that are included in the received inquiry request, an inquiry including whether there is the delinquent driving vehicle that performs the delinquent driving among other vehicles by accessing the delinquent driving database 30 via the communication interface 21, and sends an inquiry result from the delinquent driving database 30 to the vehicle 1 via the communication interface 21. The cloud server 20 receives the delinquent driving vehicle information including the ID information of the delinquent driving vehicle that performs the delinquent driving and the respective traveling trajectory information of the delinquent driving vehicle and the vehicle 1 generated by the vehicle 1 when occurrence of delinquent driving by other vehicles is detected by the vehicle 1, and registers or updates the received delinquent driving vehicle information in the delinquent driving database 30.

Accordingly, the cloud server 20 can obtain, from the vehicle 1, the delinquent driving vehicle information including the information on another vehicle that performs the delinquent driving such as pulling over to the vehicle 1 in the autonomous driving, as evidence indicating that the delinquent driving has been performed. Therefore, the cloud server 20 can register or update the delinquent driving vehicle information generated as the evidence in the widely and commonly published delinquent driving database 30, and thus can effectively promote prevention of the delinquent driving.

### Second Embodiment

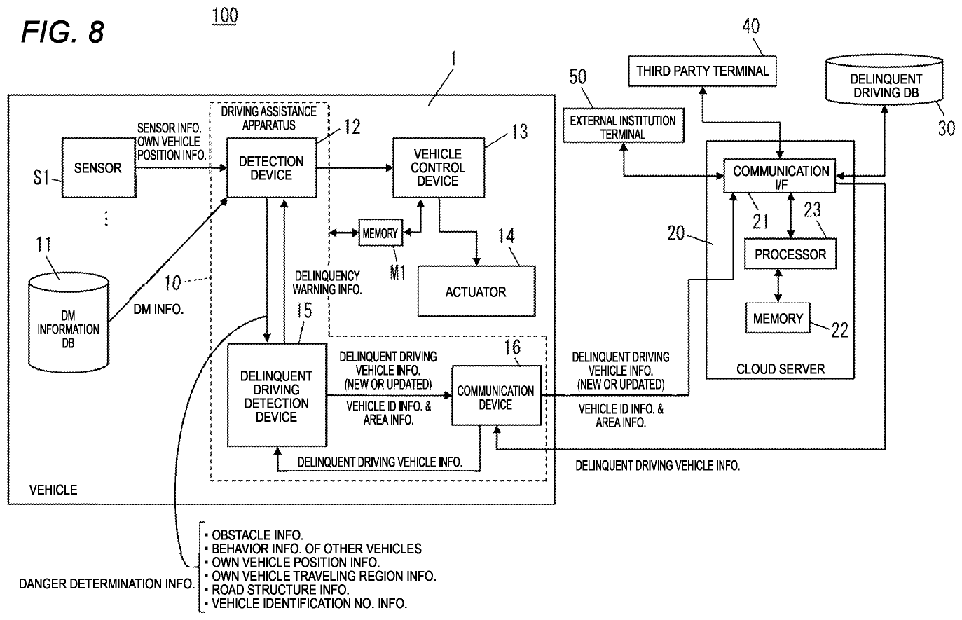

In a second embodiment, data or information used by the delinquent driving detection device 15 of the vehicle 1 to detect whether there is delinquent driving is different from that of the first embodiment. Specifically, the delinquent driving detection device 15 does not input sensor information from the plurality of sensors S1 and dynamic map data from the DM information database 11 together. The delinquent driving detection device 15 inputs danger determination information (see below) from the detection device 12, and uses the danger determination information to detect whether delinquent driving occurs (see FIG. 8).

FIG. 8 is a block diagram showing a system configuration example of the delinquent driving detection system 100 including the vehicle 1 on which the driving assistance apparatus 10 according to the second embodiment is mounted. Since a configuration of the delinquent driving detection system 100 according to the second embodiment is the same as that of the delinquent driving detection system 100 according to the first embodiment, the same reference numerals are assigned to those performing the same processing so as to simplify or omit the description, and different contents will be described.

As shown in FIG. 8, the delinquent driving detection device 15 according to the second embodiment receives the danger determination information from the detection device 12. The danger determination information is used by the delinquent driving detection device 15 according to the second embodiment to detect whether delinquent driving is performed by one other vehicle that is traveling in the vicinity of the vehicle 1 in the autonomous driving. Specifically, the danger determination information is obstacle information, behavior information of other vehicles, own vehicle position information, own vehicle traveling region information, road structure information, and vehicle identification number (No.) information.

The obstacle information is position information of an obstacle (for example, a structural object such as another vehicle, a person, and a guardrail), and is obtained by the detection device 12 based on, for example, the sensor information from the plurality of sensors S1. The same applies hereinafter.

The behavior information of other vehicles is information indicating the latest traveling trajectories of one or more other vehicles included in the obstacle (for example, the structural object such as another vehicle, the person, and the guardrail), and is obtained by the detection device 12 based on, for example, the sensor information from the plurality of sensors S1. The same applies hereinafter.

The own vehicle position information that is an example of position information is information on a current position of the vehicle 1 in the autonomous driving, and is obtained by the detection device 12 based on, for example, the sensor information from the plurality of sensors S1. The same applies hereinafter.

The own vehicle traveling region information, which is an example of traveling region information, includes a current position of the vehicle 1 in the autonomous driving, is information indicating a region within a predetermined range larger than a vehicle width of a road on which the vehicle 1 travels, and is obtained by the detection device 12 based on, for example, the sensor information from the plurality of sensors S1. The same applies hereinafter.

The road structure information is information indicating a structure of a road on which the vehicle 1 in the autonomous driving travels, and is obtained by the detection device 12 based on, for example, the dynamic map data from the DM information database 11. The same applies hereinafter.

The vehicle identification number information is number information that can be identified by another vehicle, and is obtained by the detection device 12 based on, for example, the sensor information from the plurality of sensors S1. The same applies hereinafter.

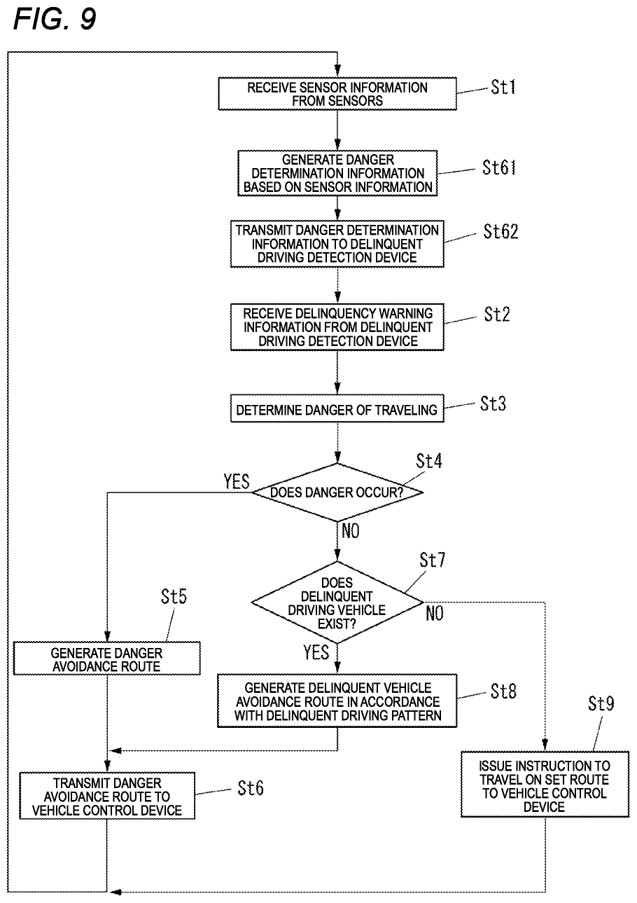

Next, an operation procedure of the detection device 12 of the driving assistance apparatus 10 according to the second embodiment will be described with reference to FIG. 9. FIG. 9 is a flowchart showing an example of the operation procedure of the detection device mounted on the driving assistance apparatus 10 according to the second embodiment. As a premise of the description of FIG. 9, the vehicle 1 is being autonomously driven toward a destination designated by an operation of a user such as a driver.

In description of FIG. 9, the same processings as those of the corresponding detection device 12 of the first embodiment shown in FIG. 3 are assigned the same step numbers so as to simplify or omit the description, and different contents will be described.

In FIG. 9, after step St1, the detection device 12 uses the sensor information from the plurality of sensors S1 obtained in step St1 so as to generate the danger determination information (St61), and sends the generated danger determination information to the delinquent driving detection device 15 (St62). Since a processing after step St62 is the same as the processing after step St1 in FIG. 3, the description thereof is omitted.

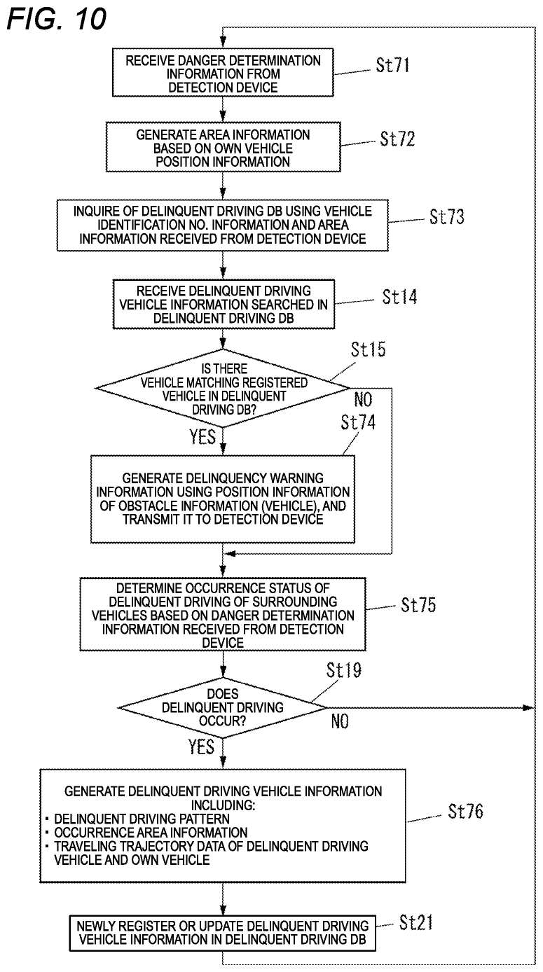

Next, the operation procedure of the delinquent driving detection device 15 of the driving assistance apparatus 10 according to the second embodiment will be described with reference to FIG. 10. FIG. 10 is a flowchart showing an example of an operation procedure of the delinquent driving detection device 15 mounted on the driving assistance apparatus 10 according to the second embodiment. As a premise of the description of FIG. 10, the vehicle 1 is being autonomously driven toward a destination designated by an operation of a user such as a driver.

In description of FIG. 10, the same processings as those of the corresponding delinquent driving detection device 15 of the first embodiment shown in FIG. 4 are assigned the same step numbers so as to simplify or omit the description, and different contents will be described.

In FIG. 10, the delinquent driving detection device 15 constantly or periodically receives the danger determination information sent from the detection device 12 (St71). The delinquent driving detection device 15 generates area information based on own vehicle position information included in the danger determination information obtained in step St71 (St72). For example, if position information of the vehicle 1 is “CC town, BB district, AA city”, the delinquent driving detection device 15 generates the area information that is the wide-area “AA city” including the “CC town”. The delinquent driving detection device 15 generates the wide area information from the position information of the vehicle 1 and uses the area information for an inquiry request to the cloud server 20. Accordingly, the cloud server 20 can rapidly make an inquiry specific to a current area where the vehicle 1 travels.

The delinquent driving detection device 15 generates an inquiry request including the vehicle identification number information included in the danger determination information received in step St71 and the area information generated in step St72 in order to inquire of the cloud server 20 whether the delinquent driving vehicle that performs the delinquent driving previously exists among one or more other vehicles in the vicinity of the vehicle 1. The delinquent driving detection device 15 transmits the generated inquiry request to the cloud server 20 via the communication device 16 (St73).

In response to the inquiry request generated by the delinquent driving detection device 15, the cloud server 20 searches the delinquent driving database 30 so as to determine whether another vehicle that satisfies the vehicle ID information (specifically, the vehicle identification number information) in the area information included in the inquiry request performs the delinquent driving previously. The cloud server 20 transmits a search result (that is, an inquiry result) of the delinquent driving database 30 to the vehicle 1. The inquiry result includes, for example, the vehicle identification number information included in corresponding vehicle ID information of the delinquent driving database 30 shown in FIG. 2 and various pieces of information (for example, information on a delinquent driving pattern and a frequency) associated with the vehicle identification number information.

The delinquent driving detection device 15 receives, via the communication device 16, the inquiry result of the delinquent driving database 30 transmitted from the cloud server 20 (St14). Based on the inquiry result of the delinquent driving database 30, the delinquent driving detection device 15 determines whether the vehicle identification number information received in step St71 is registered in the delinquent driving database 30 (in other words, whether another vehicle in the vicinity of the vehicle 1 performs the delinquent driving previously) (St15). When it is determined that the vehicle identification number information is not registered in the delinquent driving database 30 (St15, NO), the processing of the delinquent driving detection device 15 proceeds to step St75.

On the other hand, when determining that the vehicle ID information is registered in the delinquent driving database 30 (St15, YES), the delinquent driving detection device 15 uses the obstacle information (that is, position information of another vehicle that travels in the vicinity of the vehicle 1) received in step St71 so as to generate delinquency warning information (see above) (St74). The delinquent driving detection device 15 sends the generated delinquency warning information to the detection device 12 (St74).

After step St74, the delinquent driving detection device 15 determines an occurrence status of delinquent driving (in other words, whether the delinquent driving occurs) by one or more other vehicles in the vicinity of the vehicle 1 (own vehicle) based on the danger determination information received in step St71 (St75). When the delinquent driving by one or more other vehicles in the vicinity of the vehicle 1 does not occur (St19, NO), the processing of the delinquent driving detection device 15 returns to step St71.

After step St75, when determining that the delinquent driving by one or more other vehicles in the vicinity of the vehicle 1 (own vehicle) occurs (St19, YES), the delinquent driving detection device 15 generates delinquent driving vehicle information corresponding to another vehicle that performs the delinquent driving (St76). The delinquent driving vehicle information generated in step St76 includes, for example, information on an area where the delinquent driving occurs, delinquent driving pattern information, and data indicating respective traveling trajectories of a delinquent driving vehicle (that is, another vehicle that performs the delinquent driving to the vehicle 1) and the vehicle 1 (own vehicle). The delinquent driving vehicle information is used as evidence information used when an external institution (see above) such as a police station or an automobile insurance company determines whether there is a sanction. Since a processing after step St76 is the same as the processing after step St20 in FIG. 4, description thereof will be omitted.

As described above, in the delinquent driving detection system 100 according to the second embodiment, the delinquent driving detection device 15 of the vehicle 1 receives the obstacle information, behavior information of other vehicles, and the identification number information of other vehicles (for example, the vehicle identification number information) sent from the detection device 12 as information on other vehicles. Further, the delinquent driving detection device 15 receives the own vehicle traveling region information of the vehicle 1, the own vehicle position information of the vehicle 1, and the road structure information sent from the detection device 12. These pieces of obstacle information, behavior information of other vehicles, own vehicle position information, own vehicle traveling region information, road structure information, and vehicle identification number information are the danger determination information. Accordingly, when the delinquent driving detection device 15 detects whether there is the delinquent driving, the vehicle 1 does not use the sensor information from the plurality of sensors S1 as compared with the first embodiment, but uses the danger determination information whose information amount is smaller than that of the sensor information, and thus can reduce a processing load when detecting whether there is the delinquent driving.

### First Modified Example

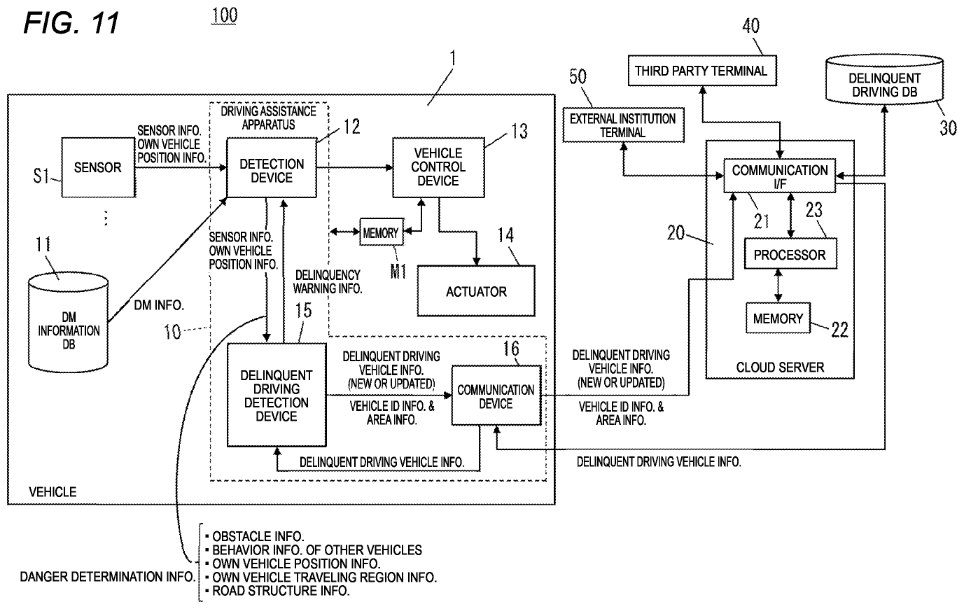

In a first modified example, data or information used by the delinquent driving detection device 15 of the vehicle 1 to detect whether there is delinquent driving is different from those of the first embodiment and the second embodiment. Specifically, the delinquent driving detection device 15 does not input dynamic map data from the DM information database 11. The delinquent driving detection device 15 inputs danger determination information (see below) from the detection device 12 and sensor information from the plurality of sensors S1, and uses these various pieces of input information to detect whether the delinquent driving occurs (see FIG. 11).

FIG. 11 is a block diagram showing a system configuration example of the delinquent driving detection system 100 including the vehicle 1 on which the driving assistance apparatus 10 according to the first modified example is mounted. Since a configuration of the delinquent driving detection system 100 according to the first modified example is the same as that of the delinquent driving detection system 100 according to the first embodiment, the same reference numerals are assigned to those performing the same processing so as to simplify or omit the description, and different contents will be described.

As shown in FIG. 11, the delinquent driving detection device 15 according to the first modified example receives the danger determination information from the detection device 12. The danger determination information according to the first modified example is used by the delinquent driving detection device 15 according to the first modified example to detect whether the delinquent driving is performed by one other vehicle that travels in the vicinity of the vehicle 1 in autonomous driving. Specifically, the danger determination information is obstacle information, behavior information of other vehicles, own vehicle position information, own vehicle traveling region information, and road structure information. That is, unlike a danger determination signal according to the second embodiment, vehicle identification number (No.) information is not included, which is because the sensor information from the plurality of sensors S1 is input to the delinquent driving detection device 15, and the detection device 12 does not need to send the vehicle identification number (No.) information to the delinquent driving detection device 15.

Regarding operation procedures of the detection device 12 and the delinquent driving detection device 15 of the vehicle 1 according to the first modified example, information input to the delinquent driving detection device 15 is different, an operation of the detection device 12 is a combination of the operation procedures shown in FIGS. 3 and 9, and an operation of the delinquent driving detection device 15 is a combination of the operation procedures shown in FIGS. 4 and 10, and thus description thereof is omitted.

As described above, in the delinquent driving detection system 100 according to the first modified example, the delinquent driving detection device 15 of the vehicle 1 receives the obstacle information, and behavior information of other vehicles sent from the detection device 12 as information on other vehicles. Further, the delinquent driving detection device 15 receives the own vehicle traveling region information of the vehicle, the own vehicle position information of the vehicle, and the road structure information sent from the detection device 12. These pieces of obstacle information, behavior information of other vehicles, own vehicle position information, own vehicle traveling region information, and road structure information are the danger determination information. Accordingly, when the delinquent driving detection device 15 detects whether there is the delinquent driving, the vehicle 1 uses the danger determination information from the detection device 12 as compared with the first embodiment, and thus can reduce a processing load when detecting whether there is the delinquent driving.

### Second Modified Example

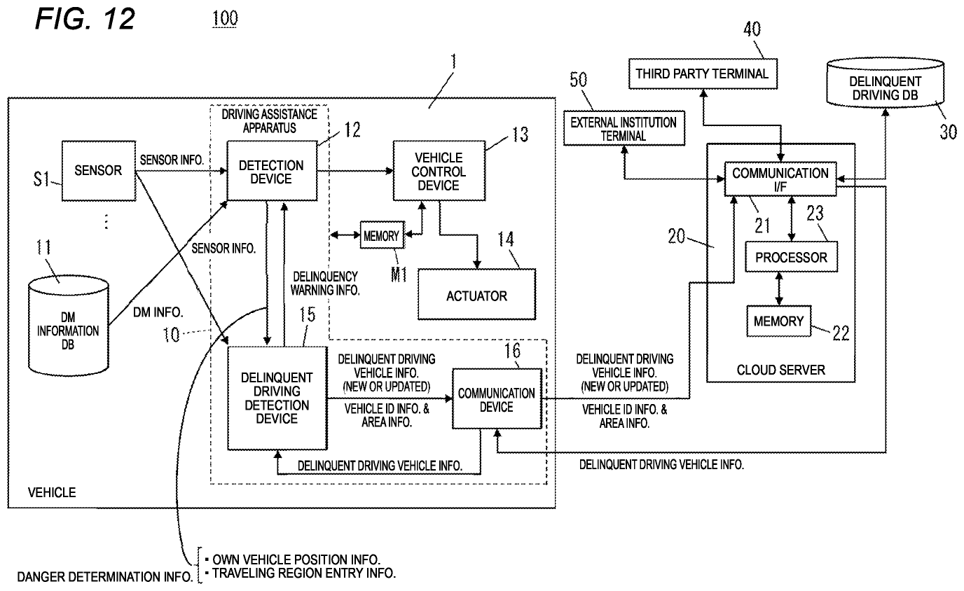

In a second modified example, data or information used by the delinquent driving detection device 15 of the vehicle 1 to detect whether there is delinquent driving is different from those of the first embodiment and the second embodiment. Specifically, the delinquent driving detection device 15 does not input dynamic map data from the DM information database 11. The delinquent driving detection device 15 inputs danger determination information (see below) from the detection device 12 and sensor information from the plurality of sensors S1, and uses these various pieces of input information to detect whether the delinquent driving occurs (see FIG. 12).

FIG. 12 is a block diagram showing a system configuration example of the delinquent driving detection system 100 including the vehicle 1 on which the driving assistance apparatus 10 according to the second modified example is mounted. Since a configuration of the delinquent driving detection system 100 according to the second modified example is the same as that of the delinquent driving detection system 100 according to the first embodiment, the same reference numerals are assigned to those performing the same processing so as to simplify or omit the description, and different contents will be described.

As shown in FIG. 12, the delinquent driving detection device 15 according to the second modified example receives the danger determination information from the detection device 12. The danger determination information according to the second modified example is used by the delinquent driving detection device 15 according to the second modified example as trigger information for starting a processing of detecting whether the delinquent driving is performed by one other vehicle that travels in the vicinity of the vehicle 1 in autonomous driving. Specifically, the danger determination information is traveling region entry information and own vehicle position information. The traveling region entry information is information indicating that another vehicle in the vicinity enters within a predetermined distance from the vehicle 1 (own vehicle). The predetermined distance is, for example, a distance that is a little further than a distance at which a collision can be avoided when another vehicle performs the delinquent driving (for example, sudden braking).

Regarding operation procedures of the detection device 12 and the delinquent driving detection device 15 of the vehicle 1 according to the second modified example, information input to the delinquent driving detection device 15 is different, an operation of the detection device 12 is a combination of the operation procedures shown in FIGS. 3 and 9, and an operation of the delinquent driving detection device 15 is a combination of the operation procedures shown in FIGS. 4 and 10, and thus description thereof is omitted. When receiving the danger determination information sent from the detection device 12, the delinquent driving detection device 15 starts status determination of whether the delinquent driving occurs.

As described above, in the delinquent driving detection system 100 according to the second modified example, the delinquent driving detection device 15 of the vehicle 1 receives the sensor information including the vehicle identification number information of other vehicles sent from the plurality of sensors S1, and receives the information on entry into the traveling region of the vehicle 1 by another vehicle (that is, the traveling region entry information) and the own vehicle position information sent from the detection device 12. Accordingly, when the delinquent driving detection device 15 detects whether there is the delinquent driving, the vehicle 1 starts detecting whether there is the delinquent driving for a first time at a time point at which the traveling region entry information is received even when the sensor information from the plurality of sensors S1 is input as compared with the first embodiment, and thus can reduce a processing load when detecting whether there is the delinquent driving.

### Third Modified Example

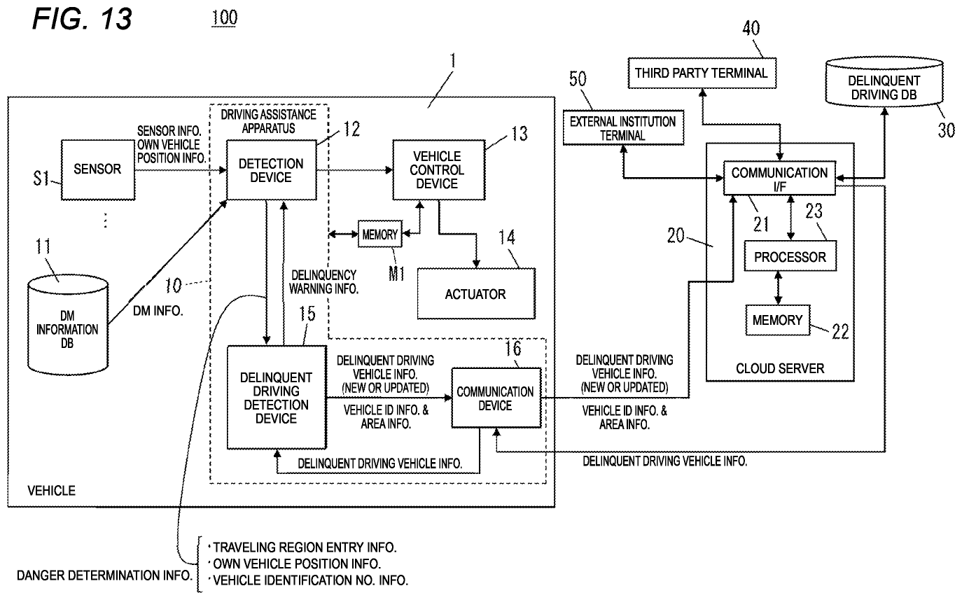

In a third modified example, data or information used by the delinquent driving detection device 15 of the vehicle 1 to detect whether there is delinquent driving is different from those of the first embodiment and the second embodiment. Specifically, the delinquent driving detection device 15 does not input sensor information from the plurality of sensors S1 and dynamic map data from the DM information database 11. The delinquent driving detection device 15 inputs danger determination information (see below) from the detection device 12, and uses the input danger determination information to detect whether the delinquent driving occurs (see FIG. 13).

FIG. 13 is a block diagram showing a system configuration example of the delinquent driving detection system 100 including the vehicle 1 on which the driving assistance apparatus 10 according to the third modified example is mounted. Since a configuration of the delinquent driving detection system 100 according to the third modified example is the same as that of the delinquent driving detection system 100 according to the first embodiment, the same reference numerals are assigned to those performing the same processing so as to simplify or omit the description, and different contents will be described.

As shown in FIG. 13, the delinquent driving detection device 15 according to the third modified example receives the danger determination information from the detection device 12. The danger determination information according to the third modified example is used by the delinquent driving detection device 15 according to the third modified example to detect whether the delinquent driving is performed by one other vehicle that travels in the vicinity of the vehicle 1 in autonomous driving. Specifically, the danger determination information is traveling region entry information, own vehicle position information, and vehicle identification number (No.) information.

Regarding operation procedures of the detection device 12 and the delinquent driving detection device 15 of the vehicle 1 according to the third modified example, information input to the delinquent driving detection device 15 is different, an operation of the detection device 12 follows the operation procedure shown in FIG. 9, and an operation of the delinquent driving detection device 15 follows the operation procedure shown in FIG. 10, and thus description thereof is omitted.

As described above, in the delinquent driving detection system 100 according to the third modified example, the delinquent driving detection device 15 of the vehicle 1 receives the information on entry into the traveling region of the vehicle 1 by another vehicle (that is, the traveling region entry information), the own vehicle position information, and the identification number information of other vehicles sent from the detection device 12. These traveling region entry information, own vehicle position information, and vehicle identification number (No.) information are the danger determination information. Accordingly, when the delinquent driving detection device 15 detects whether there is the delinquent driving, the vehicle 1 detects whether there is the delinquent driving based on the traveling region entry information without inputting the sensor information from the plurality of sensors S1 as compared with the first embodiment, and thus can further reduce a processing load when detecting whether there is the delinquent driving.

Although various embodiments are described above with reference to the drawings, it is needless to say that the present disclosure is not limited to such examples. It will be apparent to those skilled in the art that various alterations, modifications, substitutions, additions, deletions, and equivalents can be conceived within the scope of the claims, and it should be understood that such changes also belong to the technical scope of the present disclosure. Each component in the various embodiments mentioned above may be combined arbitrarily in the range without deviating from the spirit of the invention.

In the above-described embodiments, although it is described that the inquiry request including the vehicle ID information and the area information of the vehicle 1 is used when inquiring of the delinquent driving database 30 via the cloud server 20 from the vehicle 1, an inquire may be made using at least one of the vehicle ID information and the area information of the vehicle 1.

The present application is based on a Japanese patent application (Japanese Patent Application No. 2018-070018) filed on Mar. 30, 2018, the contents of which are incorporated herein by reference.

The present disclosure is useful as a driving assistance apparatus, a vehicle, a delinquent driving detection system and a server device that efficiently determine whether delinquent driving such as pulling over is performed to an own vehicle in autonomous driving, generate information on another vehicle that performs the delinquent driving as evidence, register or update the generated evidence in a predetermined database, and effectively promote prevention of the delinquent driving.

1. A driving assistance apparatus comprising:
a processor; and
a memory comprising instructions that, when executed by the processor, cause the processor to perform operations comprising:
a detection process comprising:
determining whether there is a change in a route during autonomous driving based on sensor information obtained from a sensor provided in a vehicle; and
outputting an instruction to execute autonomous driving in accordance with a determination result to a vehicle controller; and
a delinquent driving detection process comprising:
inquiring of an external database, using at least one of information on one or more other vehicles in a vicinity of the vehicle in autonomous driving and area information comprising a point where the vehicle is positioned, about whether there is a delinquent driving vehicle that has performed delinquent driving among the one or more other vehicles;
detecting presence or absence of delinquent driving by the one or more other vehicles based on an inquiry result from the database;
generating, in response to detection of the presence of the delinquent driving, delinquent driving vehicle information comprising ID information of a delinquent driving vehicle that performs the delinquent driving and traveling trajectory information of the delinquent driving vehicle and the vehicle; and
requesting the database that the delinquent driving vehicle information be registered or updated.

2. The driving assistance apparatus according to claim 1,
wherein in the delinquent driving detection process, the presence or absence of delinquent driving by the one or more other vehicles is detected if the inquiry result indicates that there is the delinquent driving vehicle in the one or more other vehicles.

3. The driving assistance apparatus according to claim 2,
wherein the inquiry result comprises information on a pattern and a frequency of the delinquent driving, and
wherein in the delinquent driving detection process, the presence or absence of delinquent driving by the one or more other vehicles is detected based on the information on the pattern or the frequency of the delinquent driving.

4. The driving assistance apparatus according to claim 2,
wherein in the delinquent driving detection process, the presence or absence of delinquent driving by the one or more other vehicles is detected based on the sensor information if the inquiry result indicates that there is no delinquent driving vehicle in the one or more other vehicles.

5. The driving assistance apparatus according to claim 1,
wherein the delinquent driving detection process further comprises:
generating delinquency warning information using the inquiry result, the delinquency warning information indicating a feature of the delinquent driving vehicle; and
delivering the delinquency warning information to the detection process, and
wherein the detection process, if at least one of the one or more other vehicles satisfying the delinquency warning information is detected, further comprises:
generating a delinquency avoidance route in accordance with the delinquency warning information; and
outputting the delinquency avoidance route to the vehicle controller.

6. The driving assistance apparatus according to claim 5,
wherein the delinquency warning information comprises information on a pattern of the delinquent driving, and
wherein in the detection process, the delinquency avoidance route is generated in accordance with the pattern of the delinquent driving.

7. The driving assistance apparatus according to claim 6,
wherein the delinquency warning information comprises information on a frequency of the delinquent driving, and
wherein in the detection process, the delinquency avoidance route is generated in accordance with the pattern and the frequency of the delinquent driving.

8. The driving assistance apparatus according to claim 7,
wherein in the detection process, the delinquency avoidance route is generated if the frequency is equal to or larger than a threshold.

9. The driving assistance apparatus according to claim 5,
wherein in the delinquent driving detection process, the delinquency warning information is generated if the inquiry result indicates that there is the delinquent driving vehicle in the one or more other vehicles.

10. The driving assistance apparatus according to claim 1,
wherein the delinquent driving detection process further comprises receiving, as the information on the one or more other vehicles, identification number information of the one or more other vehicles and feature information of the one or more other vehicles and drivers, which are included in the sensor information.

11. The driving assistance apparatus according to claim 1,
wherein the detection process further comprises:
generating danger determination information based on the sensor information; and
delivering the danger determination information to the delinquent driving detection process.

12. The driving assistance apparatus according to claim 11,
wherein the delinquent driving detection process further comprises:
receiving, as the information on the other vehicles, obstacle information, behavior information of the one or more other vehicles, and identification number information of the one or more other vehicles, which are included in the danger determination information delivered from the detection process; and
further receiving traveling region information of the vehicle, position information of the vehicle, and road structure information, which are included in the danger determination information.

13. The driving assistance apparatus according to claim 12,
wherein the delinquent driving detection process further comprises:
generating delinquency warning information using the inquiry result and the obstacle information, the delinquency warning information indicating a feature of the delinquent driving vehicle; and
delivering the delinquency warning information to the detection process, and
wherein the detection process, if at least one of the one or more other vehicles satisfying the delinquency warning information is detected, further comprises:
generating a delinquency avoidance route in accordance with the delinquency warning information; and
outputting the delinquency avoidance route to the vehicle controller.

14. The driving assistance apparatus according to claim 11,
wherein the delinquent driving detection process further comprises:
receiving the sensor information comprising identification number information of the one or more other vehicles sent from the sensor;
receiving, as information on the one or more other vehicles, obstacle information and behavior information of the one or more other vehicles, which are included in the danger determination information delivered from the detection process; and
further receiving traveling region information of the vehicle, position information of the vehicle, and road structure information, which are included in the danger determination information.

15. The driving assistance apparatus according to claim 11,
wherein the delinquent driving detection process further comprises:
receiving the sensor information comprising identification number information of other vehicles sent from the sensor; and
receiving the danger determination information delivered from the detection process, the danger determination information comprising information on entry into a traveling region of the vehicle by the one or more other vehicles and position information of the vehicle.

16. The driving assistance apparatus according to claim 15,
wherein the delinquent driving detection process further comprises:
starting detection of the presence or absence of delinquent driving by the one or more other vehicles in response to reception of the danger determination information as a trigger.

17. The driving assistance apparatus according to claim 11,
wherein the delinquent driving detection process further comprises receiving the danger determination information delivered from the detection process, the danger determination information comprising information on entry into a traveling region of the vehicle by the one or more other vehicles, position information of the vehicle, and identification number information of the one or more other vehicles.

18. A vehicle comprising:
the driving assistance apparatus according to claim 1;
the sensor; and
the vehicle controller.

19. A delinquent driving detection system comprising:
a server device configured to access a database that holds information on a delinquent driving vehicle that has performed delinquent driving; and
a vehicle comprising a sensor and a vehicle controller,
wherein the server device and the vehicle are connected to communicate with each other,
wherein the vehicle comprises:
a first processor; and
a first memory comprising first instructions that, when executed by the first processor, cause the first processor to perform first operations comprising:
determining whether there is a change in a route during autonomous driving based on sensor information obtained from the sensor;
outputting an instruction to execute autonomous driving in accordance with a determination result to the vehicle controller; and
inquiring of the server device, using at least one of information on one or more other vehicles in a vicinity of the vehicle in autonomous driving and area information comprising a point where the vehicle is positioned, about whether there is a delinquent driving vehicle that has performed delinquent driving among the one or more other vehicles,
wherein the server device comprises:
a second processor; and
a second memory comprising second instructions that, when executed by the second processor, cause the second processor to perform second operations comprising:
in response to an inquiry from the vehicle, accessing the database and receiving an inquiry result in accordance with the inquiry from the vehicle; and
transmitting the inquiry result to the vehicle, and
wherein the first operations further comprise:
detecting presence or absence of delinquent driving by the one or more other vehicles based on the inquiry result transmitted from the server device and the sensor information obtained from the sensor;
generating, in response to detection of the presence of the delinquent driving, delinquent driving vehicle information comprising ID information of a delinquent driving vehicle that performs the delinquent driving and traveling trajectory information of the delinquent driving vehicle and the vehicle; and
requesting the server device that the delinquent driving vehicle information be registered or updated.

20. A server device comprising:
a communication device configured to communicate with a vehicle and a database that holds information on a delinquent driving vehicle that has performed delinquent driving;
a processor; and
a memory comprising instructions that, when executed by the processor, cause the processor to perform operations comprising:
receiving, from the vehicle in autonomous driving via the communication device, an inquiry request for inquiring about whether there is a delinquent driving vehicle that has performed delinquent driving among one or more other vehicles in a vicinity of the vehicle in autonomous driving, the inquiry request comprising at least one of information on the one or more other vehicles and area information comprising a point where the vehicle is positioned;
accessing the database via the communication device to inquire, based on the information on the one or more other vehicles and the area information included in the received inquiry request, about whether there is the delinquent driving vehicle that has performed delinquent driving among the one or more other vehicles;
transmitting an inquiry result from the database to the vehicle via the communication unit;
receiving delinquent driving vehicle information generated by the vehicle in response to detection of a presence of the delinquent driving by the one or more other vehicles, the delinquent driving vehicle information comprising ID information of a delinquent driving vehicle that performs the delinquent driving and traveling trajectory information of the delinquent driving vehicle and the vehicle; and
requesting the database that the delinquent driving vehicle information be registered or updated.
